(19) United States
(12) Patent Application Publication
(10) Pub. No.: US 2021/0133886 A1
(43) Pub. Date: May 6, 2021

(54) Providing Insurance Coverage Using Temporary Vehicle-Related Risk Data

(71) Applicant: STATE FARM MUTUAL AUTOMOBILE INSURANCE COMPANY, Bloomington, IL (US)

(72) Inventors: Aaron Williams, Congerville, IL (US); Justin Davis, Normal, IL (US); Kristopher Keith Gaudin, Bloomington, IL (US); Leo Nelson Chan, Normal, IL (US)

(21) Appl. No.: 15/863,284

(22) Filed: Jan. 5, 2018

Related U.S. Application Data
(60) Provisional application No. 62/515,923, filed on Jun. 6, 2017.
(60) Provisional application No. 62/509,557, filed on May 22, 2017.
(60) Provisional application No. 62/474,900, filed on Mar. 22, 2017.
(60) Provisional application No. 62/449,405, filed on Jan. 23, 2017.
(60) Provisional application No. 62/447,240, filed on Jan. 17, 2017.

(51) Int. Cl. G06Q 40/08

(52) U.S. Cl. CPC G06Q 40/08

(57) ABSTRACT

A computer-implemented method of providing insurance coverage using temporary risk data may include: (1) receiving data indicative of a risk of a loss associated with a vehicle; (2) determining, based upon the data indicative of the risk, whether the risk of the loss associated with the vehicle is temporarily different from an ordinary risk of the loss; (3) determining, when the risk of the loss is temporarily different from the ordinary risk, one or more terms of temporary insurance coverage for the loss having the risk that is temporarily different from the ordinary risk; and (4) providing an indication that the temporary insurance coverage for the loss is provided and/or is to be provided. As a result, insurance-cost savings may be passed on to risk averse customers.

### CROSS-REFERENCES TO RELATED APPLICATIONS

This application claims the benefit of (1) U.S. Provisional Patent Application No. 62/447,240, entitled “Providing Temporary Insurance Coverage Using Temporary Risk Data,” filed Jan. 17, 2017, (2) U.S. Provisional Patent Application No. 62/449,405, entitled “Providing Temporary Insurance Coverage Using Temporary Risk Data,” filed Jan. 23, 2017, (3) U.S. Provisional Patent Application No. 62/474,900, entitled “Providing Temporary Insurance Coverage Using Temporary Risk Data,” filed Mar. 22, 2017, (4) U.S. Provisional Patent Application No. 62/509,557, entitled “Providing Temporary Insurance Coverage Using Temporary Risk Data,” filed May 22, 2017, and (5) U.S. Provisional Patent Application No. 62/515,923, entitled “Providing Temporary Insurance Coverage Using Temporary Risk Data,” filed Jun. 6, 2017, the disclosure of each of which is hereby expressly incorporated by reference herein in its entirety.

### FIELD OF THE DISCLOSURE

The present disclosure generally relates to insurance coverage and, more particularly, to systems and methods for providing insurance coverage using temporary vehicle-related risk data.

### BACKGROUND

A party, such as a person or business, may have one or more types of insurance coverage issued by an insurance provider. Thus, in some scenarios, the party may have life insurance coverage, liability insurance coverage, homeowners or renters insurance coverage, automotive insurance coverage, health insurance coverage, etc. Typically, such insurance coverage is on an annual or other basis that may be chosen by the insurance provider with respect to a number of insured parties or that may be conventional in the insurance industry. Obtaining and maintaining conventional insurance coverage of various types in this manner has several drawbacks.

### BRIEF SUMMARY

The present embodiments may relate to providing on-demand services or products. For instance, a predictive offering may be based upon smart/cognitive analytics to prompt on-demand offers for insurance or increased coverage for a finite, and generally shorter timeframe than traditional insurance.

In one aspect, it may be determined whether a risk of a loss associated with a vehicle is temporarily higher, lower, or otherwise different from an ordinary (e.g., predetermined) risk of the loss. For instance, the ordinary risk of the loss may be an average risk of a loss of the same type for which the risk is determined. When the risk of the loss is temporarily higher (or lower, or otherwise different from ordinary), terms of temporary insurance coverage may be determined, and such temporary insurance coverage may be offered and/or provided to a party associated with the vehicle. As described herein, a risk of a loss that is “temporarily different” than ordinary may include a risk of a loss associated with a party that is temporarily higher than an ordinary risk of the loss, a risk of the loss associated with the party that is temporarily lower than the ordinary risk of the loss, and/or a risk of the loss associated with the party that otherwise temporarily differs from the ordinary risk of the loss. Providing of such temporary insurance coverage for a short duration and in an “on demand” fashion, where the party obtains the temporary insurance coverage when the temporary insurance coverage is likely to be needed and for a duration for which the temporary insurance coverage is likely to be needed, better customizes insurance coverage to the actual needs and risks of the party. As described herein, temporary insurance coverage may refer to insurance coverage that provides, among other attributes of such insurance coverage, (i) an increased or reduced level or levels of insurance coverage relative to a level or levels of insurance coverage that the party has (or does not have) under a conventional (e.g., annual-basis) insurance policy or policies, and/or (ii) otherwise different insurance coverage (e.g., different terms of insurance coverage).

In another aspect, a computer-implemented method of providing insurance coverage using temporary risk data may be provided. The method may include (1) receiving, by at least one of (i) one or more processors or (ii) one or more transceivers or sensors, data indicative of a risk of a loss associated with a vehicle; (2) determining, by the one or more processors, based upon the data indicative of the risk of the loss associated with the vehicle, whether the risk of the loss associated with the vehicle is temporarily different from an ordinary risk of the loss, the risk of the loss being temporarily different from the ordinary risk of the loss when the risk of the loss is lower or higher than the ordinary risk of the loss for at least one of (i) a predetermined amount of time, (ii) less than the predetermined amount of time, (iii) a predetermined distance, (iv) less than the predetermined distance, (v) less or more than a distance associated with a usage-based auto insurance policy that is issued to the party and covers the vehicle, or (vi) less or more than an amount of time associated with the usage-based auto insurance policy; (3) determining, by the one or more processors when the risk of the loss is temporarily different from the ordinary risk of the loss, one or more terms of temporary insurance coverage for the loss having the risk that is temporarily different from the ordinary risk of the loss based upon at least one of an amount by which the risk of the loss is temporarily lower or higher than the ordinary risk of the loss, a duration for which the risk of the loss is to be temporarily lower or higher than the ordinary risk of the loss, or a distance for which the risk of the loss is to be temporarily lower or higher than the ordinary risk of the loss; and/or (4) providing, by the at least one of the one or more processors or the one or more transceivers or sensors, an indication that the temporary insurance coverage at least one of is provided or is to be provided, the temporary insurance coverage at least one of being provided or to be provided for an amount of time or for a distance based upon the duration or the distance, respectively, for which the risk of the loss is to be temporarily lower or higher than the ordinary risk of the loss, the temporary insurance coverage covering the vehicle for the loss having the risk that is temporarily different from the ordinary risk of the loss. The method may include additional, less, or alternate actions, including those discussed elsewhere herein.

In yet another aspect, a computer system for providing insurance coverage using temporary risk data may be provided. The computer system may include at least one of (i) one or more processors, or (ii) one or more transceivers or sensors. The computer system may be configured to (1) receive data indicative of a risk of a loss associated with a vehicle; (2) determine, based upon the data indicative of the risk of the loss associated with the vehicle, whether the risk of the loss associated with the vehicle is temporarily different from an ordinary risk of the loss, the risk of the loss being temporarily different from the ordinary risk of the loss when the risk of the loss is lower or higher than the ordinary risk of the loss for at least one of (i) a predetermined amount of time, (ii) less than the predetermined amount of time, (iii) a predetermined distance, (iv) less than the predetermined distance, (v) less or more than a distance associated with a usage-based auto insurance policy that is issued to the party and covers the vehicle, or (vi) less or more than an amount of time associated with the usage-based auto insurance policy; (3) determine, when the risk of the loss is temporarily different from the ordinary risk of the loss, one or more terms of temporary insurance coverage for the loss having the risk that is temporarily different from the ordinary risk of the loss based upon at least one of an amount by which the risk of the loss is temporarily lower or higher than the ordinary risk of the loss, a duration for which the risk of the loss is to be temporarily lower or higher than the ordinary risk of the loss, or a distance for which the risk of the loss is to be temporarily lower or higher than the ordinary risk of the loss; and/or (4) provide an indication that the temporary insurance coverage at least one of is provided or is to be provided, the temporary insurance coverage at least one of being provided or to be provided for an amount of time or for a distance based upon the duration or the distance, respectively, for which the risk of the loss is to be temporarily lower or higher than the ordinary risk of the loss, the temporary insurance coverage covering the vehicle for the loss having the risk that is temporarily different from the ordinary risk of the loss. The computer system may be configured with additional, less, or alternate functionality, including that discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the system and methods disclosed herein. It should be understood that each Figure depicts an embodiment of a particular aspect of the disclosed system and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and instrumentalities shown, wherein:

FIG. 1 illustrates a block diagram of an exemplary temporary insurance coverage system 100 in accordance with an exemplary aspect of the present disclosure;

FIG. 2 illustrates an exemplary computer-implemented method 200 of providing insurance coverage using temporary risk data, in accordance with an exemplary aspect of the present disclosure;

FIG. 3 illustrates another exemplary computer-implemented method 300 of providing insurance coverage using temporary risk data, in accordance with another exemplary aspect of the present disclosure;

FIG. 4 illustrates another exemplary computer-implemented method 400 of providing insurance coverage using temporary risk data, in accordance with another exemplary aspect of the present disclosure;

FIG. 5 illustrates an exemplary computer-implemented method 500 of providing insurance coverage using temporary risk data determined using one or more devices associated with a party, in accordance with an exemplary aspect of the present disclosure;

FIG. 6 illustrates another exemplary computer-implemented method 600 of providing insurance coverage using temporary risk data determined using one or more devices associated with a party, in accordance with another exemplary aspect of the present disclosure;

FIG. 7 illustrates an exemplary computer-implemented method 700 of providing insurance coverage associated with a vehicle using temporary risk data, in accordance with an exemplary aspect of the present disclosure;

FIG. 8 illustrates another exemplary computer-implemented method 800 of providing insurance coverage associated with a vehicle using temporary risk data, in accordance with another exemplary aspect of the present disclosure;

FIG. 9 illustrates an exemplary computer-implemented method 900 of providing insurance coverage associated with a residence using temporary risk data, in accordance with an exemplary aspect of the present disclosure;

FIG. 10 illustrates another exemplary computer-implemented method 1000 of providing insurance coverage associated with a residence using temporary risk data, in accordance with another exemplary aspect of the present disclosure; and

FIG. 11 illustrates a diagram of an exemplary computing device 1100 that may implement one or more of the functionalities discussed herein, in accordance with an exemplary aspect of the present disclosure.

The Figures depict preferred embodiments for purposes of illustration only. Alternative embodiments of the systems and methods illustrated herein may be employed without departing from the principles of the invention described herein.

### DETAILED DESCRIPTION

The present embodiments relate to, inter alia, determining that a risk of a loss associated with, for instance, a residence associated with a party, a vehicle associated with the party, etc. is higher (or lower, or otherwise different) than an ordinary risk of the loss, determining one or more terms of temporary insurance coverage for the loss having the risk that is higher (or otherwise different or lower) than ordinary, and providing such temporary insurance coverage to the party.

For instance, the party may be a customer of an insurance provider, and one or more computing devices of the insurance provider may perform the aforementioned determinations and other actions described herein. In other aspects, the party may not be a customer of the insurance provider until, for instance, the temporary insurance coverage is provided to the party as further described herein. Thus, in some aspects, any person or entity may allow the one or more insurance provider computing devices to make determinations, or recommendations, regarding temporary risk such as those described herein and to offer and/or provide temporary insurance coverage to the person or entity (e.g., such a person or entity may have a suitable mobile application or “app” installed on a mobile computing device of the person or entity to facilitate such functionality). Additionally or alternatively, in other aspects, one or more devices (e.g., one or more computing devices, such as smart devices as described herein) associated with the residence, the vehicle, etc. may perform one or more determinations described herein, such as a determination that a risk of a loss associated with the residence, a risk of a loss associated with the vehicle, etc. is different from ordinary.

Accordingly, the systems and methods disclosed herein relate generally to providing temporary insurance coverage using temporary risk data. More particularly, the embodiments disclosed herein include, in some aspects, receiving data indicative of a risk of a loss associated with a party (e.g., associated with the residence, associated with the vehicle, etc.) (with the party's affirmative consent or permission, such as by opting into a rewards or other customer service program) at one or more insurance provider computing devices (e.g., an insurance provider server(s)). The loss may be any one or more suitable types of losses for which the party may already have and/or may obtain insurance coverage, such as a loss with respect to an automobile, loss with respect to a residence, loss incurred while traveling, a financial loss (e.g., due to fraud, such as fraud associated with a purchase made by the party), etc.

Aspects may include determining, based upon the data indicative of the risk of the loss associated with the party, whether the risk of the loss associated with the party is temporarily higher (or lower, or otherwise different or abnormal) than an ordinary risk of the loss. As discussed elsewhere herein, the ordinary risk of the loss may be a risk that depends upon the type of the loss and/or any other suitable factor(s), and may be, for instance, an average risk (e.g., over a period of time) that the party will sustain the loss, an average risk that any party will sustain a loss of the same type, etc.

The disclosed embodiments may, in other aspects, include determining that the risk of the loss associated with the party is temporarily different from the ordinary risk of the loss at and/or by one or more devices associated with the party (e.g., one or more computing devices and/or smart devices, as further discussed herein). In any event, the party may in some instances be a person or entity that is insured by the insurance provider associated with the one or more insurance provider computing devices before or at the time of a determination that the risk of the loss associated with the party is temporarily higher (or lower, or otherwise different) than the ordinary risk. In other instances, the party may be a person or entity that is not insured by the insurance provider before or at the time of a determination that the risk of the loss associated with the party is temporarily higher (or lower, or otherwise different) than the ordinary risk.

With reference to the discussion above, the disclosed embodiments may also include determining one or more terms of temporary insurance coverage for the loss having the risk that is higher than (or lower than, or otherwise deviates from) the ordinary risk. The one or more terms of the temporary insurance coverage are further discussed below, and in one aspect may be determined by the one or more insurance provider computing devices. In another aspect, the one or more terms of the temporary insurance coverage may be determined by the one or more devices associated with the party, such as one or more computing devices and/or smart devices, wearables, smart or intelligent home controllers, smart vehicle controllers, and/or autonomous vehicles of the party (and in some instances, a device(s) of another party or parties, as further described herein). Additionally or alternatively, in some aspects, the temporary insurance coverage may be usage-based insurance coverage, such as pay-by-time or pay-by-distance insurance coverage, as further described herein.

In various aspects, data indicative of the terms of the temporary insurance coverage may be provided to the party, the party may request the temporary insurance coverage, and/or the insurance provider may provide the temporary insurance coverage. Additionally or alternatively, the insurance provider may utilize historical data associated with the providing of the temporary insurance coverage to adjust a marketing profile of the party, adjust one or more terms of longer-duration insurance coverage provided and/or offered to the party, and/or for any other suitable purpose(s).

In light of the foregoing and the discussion elsewhere herein, it will be appreciated that the disclosed systems and methods provide the ability to, inter alia, determine temporary risk data, use such temporary risk data to determine whether a risk of a loss associated with a party is temporarily higher (or lower, or otherwise different) than an ordinary risk of the loss, and/or determine one or more terms of temporary insurance coverage to be offered and/or provided for the loss—even in situations where the party is not already insured by an insurance provider at the time the insurance provider provides the temporary insurance coverage. Thus, among other advantages or improvements, the disclosed systems and methods allow computerized determining of terms of temporary insurance coverage based upon whether a risk of a loss is temporarily higher (or lower, or otherwise different) than an ordinary risk of the loss, and/or allow offering and/or providing of such temporary insurance coverage to a party to insure against the loss that is temporarily higher (or lower, or otherwise different, respectively) than ordinary. The disclosed systems and methods thus allow insurance coverage to be better customized to the needs and/or actual risks faced by the party to be insured, e.g., when a given risk, or a given level or risk, of a loss associated with the party to be insured will be short in duration, the corresponding temporary insurance coverage for the loss may be of the same or similar duration. It will be appreciated in light of the teaching and disclosure herein that the disclosed systems and methods are thus directed to an improvement(s) to computer functionality and improve the functioning of conventional computers, and/or are directed to an improvement(s) in computer-related technology, and/or provide insurance coverage in a non-conventional and non-generic way, such as by the non-conventional and non-generic use of data regarding temporary risk.

Other advantages will be recognized by one of ordinary skill in the art in light of the teaching and disclosure herein. Moreover, additional features and embodiments regarding providing temporary insurance coverage using temporary risk data, or temporary risk levels, are further described below.

### Exemplary System for Providing Temporary Insurance Coverage Using Temporary Risk Data

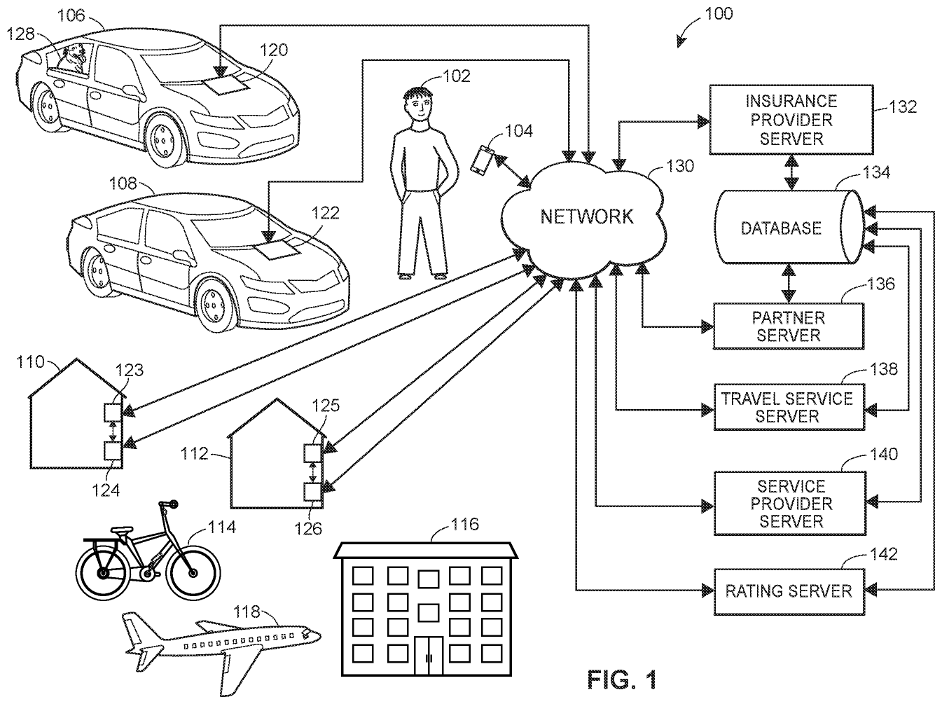

FIG. 1 illustrates a block diagram of an exemplary temporary insurance coverage system 100 in accordance with an exemplary aspect of the present disclosure. In some aspects, the temporary insurance coverage system 100 may include hardware and software entities, applications, components, and devices configured to facilitate providing temporary insurance coverage using temporary risk data. It should be appreciated that additional, fewer, or alternate entities, applications, components, and devices may be implemented.

In one aspect, as shown in FIG. 1, the temporary insurance coverage system 100 may include a party 102, which is illustrated as a person, although it should be understood that the party 102 may in some aspects include more than one person and/or an entity or entities such as a business. In an aspect, the party 102 may be a customer of an insurance provider (e.g., may have insurance coverage through the insurance provider, such as insurance coverage for one or more types of losses). Where the party 102 is a customer of the insurance provider, insurance coverage that the party 102 has through (e.g., issued by or on behalf of) the insurance provider may be “longer-duration” insurance coverage. For example, the longer-duration insurance coverage may be insurance coverage that is for at least one of a predetermined duration (e.g., a duration determined by the insurance provider or any other person or entity that may determine whether the insurance coverage constitutes longer-duration insurance coverage) or a duration longer than an amount of time for which temporary insurance coverage is to be requested, offered, and/or provided as described herein. As discussed above, in another aspect, the party 102 may not be a customer of the insurance provider until, for example, temporary insurance coverage as described herein is provided to the party 102.

The temporary insurance coverage system 100 may also include a computing device 104, which may be associated with (e.g., owned by or otherwise used by) the party 102. The computing device 104 may be any suitable type of computing device. For instance, the computing device 104 may be a mobile computing device, such as a smartphone, a tablet, a phablet, smart watch, smart glasses, wearable electronics, other mobile device, etc., and may perform actions further described herein. The temporary insurance coverage system 100 may also include a first vehicle 106 (e.g., associated with the party 102, as further described herein), which may be an autonomous or semi-autonomous vehicle; a second vehicle 108 (e.g., associated with another party, as further described herein), which may be an autonomous or semi-autonomous vehicle; a first residence 110 (e.g., associated with the party 102, as further described herein, such as a smart or intelligent home); and a second residence 112 (e.g., associated with another party, as further described herein, including intelligent homes).

In the example of FIG. 1, the temporary insurance coverage system 100 is shown as further including a bicycle 114, a hotel 116, and an airplane 118, though as will be apparent in light of the teaching and disclosure herein, additional and/or alternative elements may also be included in the temporary insurance coverage system 100. Applications of the temporary insurance coverage system 100 and related methods for providing temporary insurance coverage using the computing device 104, the first vehicle 106, the second vehicle 108, the first residence 110, the second residence 112, the bicycle 114, the hotel 116, and/or the airplane 118 are further described herein.

The first vehicle 106 (which may be an autonomous vehicle) may include a first smart vehicle controller 120; the second vehicle 108 (which also or alternatively may be an autonomous vehicle) may include a second smart vehicle controller 122; the first residence 110 may include a first smart or intelligent home controller 123 and a first smart home device 124 (e.g., a device of a smart or intelligent home monitoring and/or control system of the first residence 110, which may be in wired or wireless communication with the first smart or intelligent home controller 123); and the second residence 112 may include a second smart or intelligent home controller 125 and a second smart home device 126, which may be in wired or wireless communication with the second smart or intelligent home controller 125. The first vehicle 106 may include, in addition to passengers (e.g., the party 102 and/or another passenger(s) (not shown as such in FIG. 1)), a dog 128, cat, pet, or other animal, as further described below. Applications of the temporary insurance coverage system 100 and related methods for providing temporary insurance coverage using the first smart vehicle controller 120, the second smart vehicle controller 122, the first smart or intelligent home controller 123, the first smart home device 124, the second smart or intelligent home controller 125, and/or the second smart home device 126 are further described herein. Additionally, determination of whether the dog 128 or other animal is present within, for example, the first vehicle 106 as shown in FIG. 1 for purposes of providing temporary insurance coverage is further described herein.

With further reference to aspects including autonomous vehicles and/or parties (e.g., the party 102) traveling within autonomous vehicles, it will be appreciated that a semi-autonomous vehicle may autonomously implement any suitable number and types of driving and/or control functions, while a driver of the semi-autonomous vehicle (e.g., the party 102) may implement any suitable number and types of other driving and/or control functions. An autonomous vehicle, in some aspects, may autonomously implement all driving and/or control functions during driving of the vehicle, but in some aspects may receive inputs from a driver or other party riding in the autonomous vehicle (e.g., the party 102), such as input of a route before the autonomous vehicle begins driving. In some aspects, an autonomous vehicle may additionally or alternatively receive inputs from a driver or other party riding in the autonomous vehicle (e.g., the party 102), such as selection of an alternate route, manual control of the autonomous vehicle in case of emergency, etc.

As will be appreciated from the present teaching and disclosure, as used herein, the term “autonomous vehicle,” “autonomous vehicles,” or the like may refer to an autonomous vehicle or vehicles, a semi-autonomous vehicle or vehicles, another smart vehicle or vehicles, and/or to any suitable combination of autonomous vehicles, semi-autonomous vehicles, and/or other smart vehicles. Additionally, as used herein, the term “autonomous vehicle device,” “autonomous vehicle controller,” “autonomous vehicle control system,” “smart vehicle device,” “smart vehicle controller,” “smart vehicle control system,” or the like may refer to one or more control devices or systems that partially or entirely control operation of an autonomous or semi-autonomous vehicle (or other smart vehicle), such as in response to factors including inputs from the party 102 and/or inputs from another person(s) riding in the autonomous or semi-autonomous vehicle (or other smart vehicle).

With further reference to the discussion of autonomous vehicles elsewhere herein, an autonomous vehicle (e.g., the first vehicle 106 and/or the second vehicle 108) may drive itself along one or more routes under the control of an autonomous vehicle controller and/or other suitable autonomous vehicle device(s). For instance, the first vehicle 106 and/or the second vehicle 108 may include the first smart vehicle controller 120 and/or the second smart vehicle controller 122, respectively, which may be integrated as part of the first vehicle 106 and/or the second vehicle 108 to facilitate autonomous driving and/or other smart driving functions. A smart vehicle controller (e.g., the first smart vehicle controller 120 or the second smart vehicle controller 122) may control, or be used in controlling, the direction, movement, and/or speed of the autonomous vehicle (e.g., the first vehicle 106 or the second vehicle 108) in which the smart vehicle controller is installed. As an example, the smart vehicle controller may include or otherwise utilize one or more processors specifically designed for adaptive vision processing at high speeds and/or utilizing parallel processing techniques to facilitate autonomous (or semi-autonomous) driving. Additionally or alternatively, the smart vehicle controller may control various drive-by-wire interfaces to facilitate controlling the speed of the autonomous vehicle and to turn the autonomous vehicle without user input. To provide an additional example, the smart vehicle controller may also or alternatively include various braking controllers and/or transmission controllers to slow the autonomous vehicle and to shift the autonomous vehicle into different gears. In various aspects, sensors, meters, and/or other suitable devices may be communicatively coupled to the smart vehicle controller to facilitate autonomous (or semi-autonomous) driving.

In some aspects, the smart vehicle controller may analyze vehicle telematics data and/or other suitable data in order to determine whether a risk of a loss associated with the party 102 (e.g., a risk of the autonomous vehicle being involved in a collision with another vehicle or object) is temporarily different from an ordinary risk of the loss. Vehicle telematics data is described in further detail herein. As such, providing of temporary insurance coverage as described herein may be facilitated. Additionally or alternatively, in some aspects, if the vehicle telematics data and/or other data indicates a road hazard at a certain location and/or in a certain road lane, then the smart vehicle controller may issue one or more commands to the driving control system to steer the autonomous vehicle into a clear lane, thus avoiding the road hazard.

The smart vehicle controller may work in conjunction with a driving control system to support any suitable number and/or types of driver feedback. To provide this feedback, the autonomous vehicle may include any suitable number and/or types of displays, user interfaces, speakers, buzzers, etc. For example, the autonomous vehicle may include various feedback components to provide visual and/or auditory feedback regarding the operation of the autonomous vehicle and/or information regarding anomalous conditions, weather events, alerts, warnings, recommendations, etc., which may be based upon an analysis of vehicle telematics data and/or other suitable data. The smart vehicle controller may generate, calculate, and/or display travel routes, and may perform functions associated with the determination of whether an identified anomaly (e.g., a traffic event, travel event, abnormal condition, weather event, etc.), which has been determined from an analysis of telematics data and/or other data, is relevant to a particular travel route and/or a current location of the autonomous vehicle. As described elsewhere herein, providing of temporary insurance coverage may be facilitated based upon a determination that the identified anomaly is relevant to the particular travel route and/or the current location of the autonomous vehicle.

For instance, such a determination may be made when the identified anomaly or other abnormal condition is or will be located along a current travel route (e.g., ahead by some threshold distance in a direction of travel on the same road on which the autonomous vehicle is moving). Aspects include the smart vehicle controller, upon such a determination being made, automatically performing various preventative and/or corrective actions based upon how the relevance of the identified anomaly is determined. For example, the smart vehicle controller may issue a visual and/or audible alert via a driving control system, may calculate and display a new travel route via a driving control system, etc. In some aspects, the smart vehicle controller may automatically cause (e.g., in conjunction with a driving control system) the autonomous vehicle to, for instance, travel along the new travel route. In other aspects, a visual and/or audible alert such as that described above may indicate to a party riding in the autonomous vehicle (e.g., the party 102) that the party needs to temporarily take manual control of the autonomous vehicle, such as taking manual control of the autonomous vehicle in order to cause the autonomous vehicle to travel along the new travel route.

With further reference to the example implementation of the temporary insurance coverage system 100 shown in FIG. 1, each of the computing device 104, the first smart vehicle controller 120, the second smart vehicle controller 122, the first smart or intelligent home controller 123, the first smart home device 124, the second smart or intelligent home controller 125, and the second smart home device 126 may be communicatively coupled to a network 130, such as via any suitable wired or wireless links. The network 130 may include any suitable number of interconnected network components that form an aggregate network system. The network 130 may be or include at least a portion of a network such as the Internet and/or any other type of suitable network (e.g., a Bluetooth network, a local area network (LAN), a metropolitan area network (MAN), a wide area network (WAN), a mobile network, a wired or wireless network, a private network, a virtual private network, etc.). The network 130 may also or alternatively be or include, for instance, one or more cellular networks such as a code division multiple access (CDMA) network, a GSM (Global System for Mobile Communications) network, a WiMAX (Worldwide Interoperability for Microwave Access) network, a Long Term Evolution (LTE) network, etc.

Still further, the temporary insurance coverage system 100 is shown in FIG. 1 as including an insurance provider server 132, a database 134, a partner server 136, a travel service server 138, a service provider server 140, and a rating server 142. The insurance provider server 132 may be a server(s) or other suitable computing device(s) of the insurance provider, and may be used to provide various functionality described herein. For example, the insurance provider server 132 may determine whether a risk of a loss associated with the party 102 is temporarily different from an ordinary risk of the loss, determine one or more terms of temporary insurance coverage to be offered and/or provided to the party 102 to insure against the loss having the risk that is temporarily different from the ordinary risk, etc., as further described herein.

The database 134 may store any suitable information for access by the insurance provider server 132 and/or any other computing devices such as those illustrated in the example of FIG. 1. For example, the database 134 may store information indicative of a risk level or value that is considered (e.g., as determined by the insurance provider) to be the ordinary risk of the loss (e.g., an average risk level or value that the party 102 will sustain the loss over a particular period of time, an average risk level or value that any person or entity will sustain a loss of the same type over the particular period of time, etc.). The database 134 may also or alternatively store information such as an identification of the party 102, data received by the insurance provider server 132 (e.g., via the network 130) that is indicative of a risk of the loss associated with the party 102, map data, road data, crime data, data regarding particular merchants (e.g., historical data regarding incidents of fraudulent transactions involving particular merchants), and/or any other suitable data that may be utilized in, for example, determining a temporarily different risk, determining terms of temporary insurance coverage, etc., as described herein.

The database 134 may, in one aspect, be coupled to each of the insurance provider server 132, the partner server 136, the travel service server 138, the service provider server 140, and the rating server 142 as shown in FIG. 1. In other aspects, the database 134 may be coupled to additional and/or different devices. The database 134 may, in various aspects, store any suitable information such as that described herein as being stored by and/or used by another device(s) of the temporary insurance coverage system 100 (e.g., information that may be stored and/or used by the insurance provider server 132, as described above), instead of or in addition to such information being stored in such other device(s). The database 134 may be or may include, for instance, one or more hard disk drives, optical storage drives, solid state storage devices, etc.

The partner server 136 may be a server or other computing device of a business partner (e.g., marketing partner) of the insurance provider. In some aspects, the business partner of the insurance provider may provide (e.g., via the partner server 136) one or more affinity offers to the party 102, such as based upon data regarding a type of the risk of the loss associated with the party 102 that is temporarily different from the ordinary risk. For instance, if the type of the risk of the loss associated with the party 102 is a travel-related risk of loss, the business partner of the insurance provider may provide one or more travel-related discounts, offers, etc. to the party 102. It should be appreciated in light of the teaching and disclosure herein that the insurance provider may partner with any suitable number of business partners, and as such any suitable number of instances of the partner server 136 may be included in the temporary insurance coverage system 100. Affinity offers are further discussed elsewhere herein.

The travel service server 138 may be a server or other computing device of a travel service provider, such as a railroad, an airline, a taxi service provider, a bus service provider, a subway service provider, or any suitable type of travel service provider. In the example of FIG. 1, the travel service server 138 may be a server of an airline that provides a travel service using, for example, the airplane 118. Use of a travel service by the party 102 and providing of temporary insurance coverage to the party 102 based upon such use of a travel service is further discussed elsewhere herein.

The service provider server 140 may be a server or other computing device of a service provider such as an on-demand transportation service provider (e.g., a provider of an on-demand driving service such as that provided by Uber Technologies, Inc. of San Francisco, Calif. or Lyft, Inc. of San Francisco, Calif.), a rental automobile service, a residential cleaning service, etc. In some aspects, the service provider server 140 may store, inter alia, one or more ratings of the service (e.g., on-demand driving, home cleaning, etc.) provided by the service provider that have been submitted by one or more customers of the service provider. In other aspects, such one or more ratings may also or alternatively be stored at the rating server 142. It should be appreciated that in some instances, the service provider associated with (e.g., operating and/or using) the service provider server 140 may be the same as the travel service provider described with respect to the travel service server 138. In such instances, one of the travel service server 138 or the service provider server 140 may be omitted from the temporary insurance coverage system 100, and the service provider described with respect to such instances may be associated with the remaining one of the travel service server 138 or the service provider server 140.

In one aspect, each of the insurance provider server 132, the partner server 136, the travel service server 138, the service provider server 140, and the rating server 142 may be communicatively coupled via any suitable wired and/or wireless links to the network 130. It should be appreciated that the communicative couplings illustrated in FIG. 1 are by way of example only, and that additional and/or alternative couplings are envisioned.

Although the temporary insurance coverage system 100 is shown in FIG. 1 as including one instance of various components such as the party 102, the computing device 104, the network 130, the servers 132 and 136-142, and other components; two vehicles 106 and 108; and two residences 110 and 112, various aspects include the temporary insurance coverage system 100 implementing and/or including any suitable number of any of the components shown in FIG. 1 and/or any suitable additional component(s) (and/or any suitable number of parties that may be offered, may request, and/or may be provided temporary insurance coverage).

### Exemplary Providing of Insurance Coverage Using Temporary Risk Data

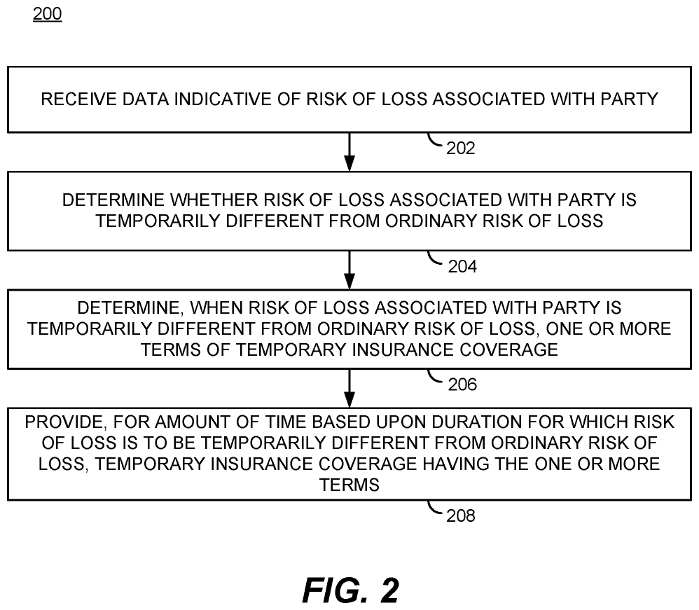

FIG. 2 illustrates an exemplary computer-implemented method 200 of providing insurance coverage using temporary risk data, in accordance with an exemplary aspect of the present disclosure. In one aspect, the method 200 may be implemented by the insurance provider server 132. For instance, the method 200 may be performed by one or more processors, applications, and/or routines that are part of, stored by, and/or otherwise accessible to the insurance provider server 132.

The method 200 may include receiving, at one or more insurance provider computing devices by at least one of (i) one or more processors or (ii) one or more transceivers of the one or more insurance provider computing devices, data indicative of a risk of a loss associated with a party (block 202). In some aspects, the one or more insurance provider computing devices may be or may include the insurance provider server 132, and/or the party may be the party 102. The data indicative of a risk of a loss associated with the party 102 may be data indicative of a level, degree, amount, etc. of a risk of any suitable type of loss associated with the party 102. Examples of types of loss for which the party 102 may be at risk, and in particular a risk that is temporarily different from an ordinary risk as discussed above, are further described in detail herein. As an example, however, the data indicative of the risk of the loss associated with the party 102 may be or may include vehicle telematics data, which may indicate the risk of the loss associated with the party 102 by indicating, for instance, a risk of the party 102 encountering congestion when driving, such as driving the first vehicle 106; a risk of the party 102 being involved in a collision when driving the first vehicle 106; a risk of the party 102 encountering inclement weather when driving the first vehicle 106; etc.

As further examples, the data indicative of the risk of the loss associated with the party 102 may indicate a risk of the first residence 110, with which the party 102 may be associated by way of rentership or ownership, being burglarized or otherwise the target of a property crime; a risk of the party 102 being involved in a collision and/or being injured while riding the bicycle 114; a risk of the party 102 incurring a loss such as a financial loss depending upon a location of the party 102; a risk of the party 102 incurring a loss while traveling, such as loss of life, loss of property (e.g., lost baggage when flying on the airplane 118), etc.; a risk of the party 102 being a victim of a fraudulent transaction with another party; and/or a risk(s) of any other suitable type(s) of loss.

The method 200 may include determining, by the insurance provider computing device 132, based upon the data indicative of the risk of the loss associated with the party 102, whether the risk of the loss associated with the party 102 is temporarily different from an ordinary risk of the loss (block 204). The ordinary risk of the loss may be, for instance, a risk of the loss determined and/or expressed as described above. In some aspects, the risk of the loss associated with the party 102 may be determined to be temporarily different from the ordinary risk of the loss when the risk of the loss associated with the party 102 is different from the ordinary risk for (i) a predetermined amount of time (e.g., an amount of time determined by the insurance provider), (ii) less than the predetermined amount of time, and/or (iii) less than a period of an insurance policy (e.g., a longer-duration insurance policy, such as that described above) that covers the loss and is issued (e.g., has already been issued by the insurance provider) to the party 102. Additionally or alternatively, in some aspects, the actions described with respect to block 204 may include a determination that the risk of the loss associated with the party 102 is temporarily different from the ordinary risk.

The method 200 may include determining, by the insurance provider server 132 when the risk of the loss associated with the party 102 is temporarily different from the ordinary risk of the loss, one or more terms of temporary insurance coverage for the loss having the risk that is temporarily different from the ordinary risk of the loss (block 206). In various aspects, the one or more terms of the temporary insurance coverage for the loss may be determined based upon an amount by which the risk of the loss is temporarily different from the ordinary risk of the loss (e.g., as determined based upon the data indicative of the risk of the loss); a duration for which the risk of the loss is to be temporarily different from the ordinary risk of the loss (e.g., as determined based upon the data indicative of the risk of the loss); a type of the loss for which the risk is temporarily different from the ordinary risk; one or more attributes of the party 102 (e.g., an occupation of the party 102, and/or other suitable attribute(s), as further discussed herein); one or more selections made by the party 102 (e.g., using the computing device 104) that are communicated to the insurance provider server 132; and/or any other suitable factors. In various aspects, the one or more terms of the temporary insurance coverage may include a deductible, a premium, an amount of time for which the temporary insurance coverage is to be in effect, an out-of-pocket maximum liability of the party 102 for the loss insured by the temporary insurance coverage; and/or other terms such as those described elsewhere herein.

The method 200 may include providing, by the insurance provider server 132, for an amount of time based upon the duration for which the risk of the loss is to be temporarily different from the ordinary risk of the loss, the temporary insurance coverage to the party 102, where the temporary insurance coverage may have the one or more terms determined as described with respect to block 206 (block 208). In some aspects, the duration for which the risk of the loss is to be temporarily different from the ordinary risk of the loss may be determined based upon the data indicative of the risk of the loss. Additionally or alternatively, in some aspects, the amount of time for which the temporary insurance coverage is to be provided may be based upon the duration for which the risk of the loss is to be temporarily different from the ordinary risk of the loss by being equal to the duration for which the risk of the loss is to be temporarily different; equal to the duration for which the risk of the loss is to be temporarily different plus a predetermined (e.g., by the insurance provider and/or the party 102) amount of time; or in any other suitable manner.

The method 200 may include additional, less, or alternate actions, including those discussed elsewhere herein, and/or may be implemented via an appropriate computing device(s) and/or processors thereof (e.g., the insurance provider server 132), or via computer-executable instructions stored on non-transitory computer-readable medium or media.

### Additional Exemplary Aspects Relating to Providing of Insurance Coverage Using Temporary Risk Data

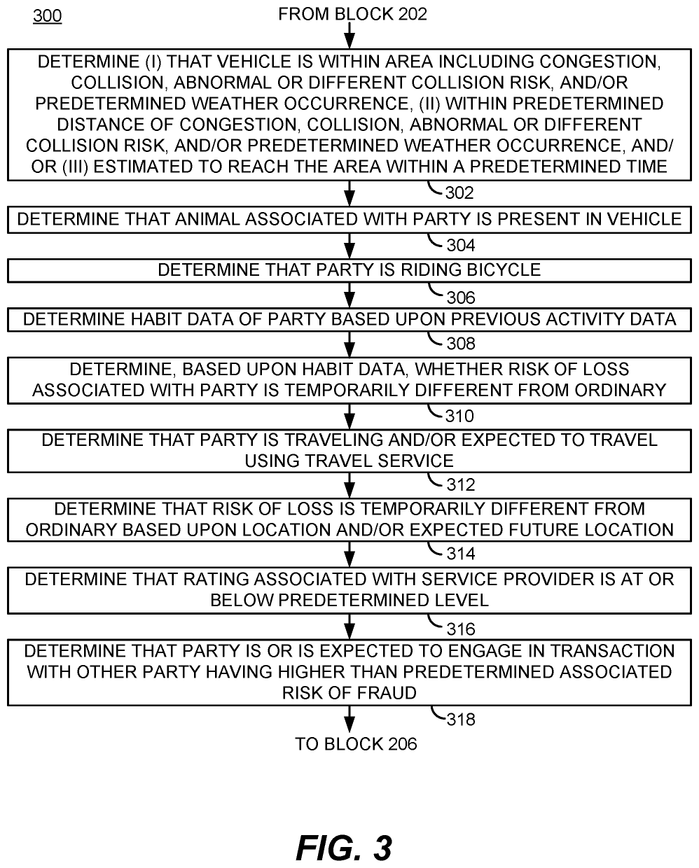

FIG. 3 illustrates another exemplary computer-implemented method 300 of providing insurance coverage using temporary risk data, in accordance with another exemplary aspect of the present disclosure. In one aspect, the method 300 may be implemented by the insurance provider server 132. For instance, the method 300 may be performed by one or more processors, applications, and/or routines that are part of, stored by, and/or otherwise accessible to the insurance provider server 132. It will be appreciated from the teaching and disclosure herein that the method 300 may include a more particular implementation(s) of aspects of the method 200.

The method 300 may include performing the actions described with respect to block 202 in order to receive the data indicative of the risk of the loss associated with the party 102. As further discussed herein, in some aspects, the data indicative of the risk of the loss associated with the party 102 may be or may include data from and/or generated by one or more devices associated with the party 102, such as the computing device 104, the first smart vehicle controller 120, the first smart home device 124, etc. As further discussed herein, such data may in some aspects include vehicle telematics data and/or intelligent home telematics data. Additionally or alternatively, in some aspects and as further discussed herein, the data indicative of the risk of the loss associated with the party 102 may be or may include data available at the insurance provider server 132.

As discussed above in relation to the actions described with respect to block 202, and as further described herein, the data indicative of the risk of the loss associated with the party 102 may be or may include vehicle telematics data (e.g., telematics data corresponding to or otherwise associated with the first vehicle 106). As also discussed above and further described herein, in various aspects, the vehicle telematics data may indicate the risk of the loss associated with the party 102 by indicating a risk of the party 102 encountering congestion when driving, such as driving the first vehicle 106; a risk of the party 102 being involved in a collision when driving the first vehicle 106; a risk of the party 102 encountering inclement weather when driving the first vehicle 106; etc. The vehicle telematics data may include, for instance, Global Positioning System (GPS) location, speed, heading or direction, lane, braking, cornering, acceleration, and/or route data of the first vehicle 106.

In various aspects, the vehicle telematics data may be generated and collected by one or more suitable devices and/or processors (e.g., by the first smart vehicle controller 120 and/or one or more processors associated therewith; by the computing device 104 and/or one or more processors thereof; and/or by any other suitable devices and/or processors). For instance, the vehicle telematics data may be generated by one or more suitable sensors, meters, and/or other suitable devices, which may be included within a smart vehicle control system, the computing device 104, etc. In various aspects, such sensors, meters, and/or other devices may include, for instance, speedometer sensors, braking sensors, airbag deployment sensors, crash detection sensors, cameras, microphones, etc. The vehicle telematics data generated by the sensors, meters, and/or other devices may be collected via the first smart vehicle controller 120 and/or one or more processors associated therewith, via a telematics mobile application (also referred to herein as a “telematics app”) executing on the computing device 104, and/or in any other suitable manner.

It should be appreciated in light of the teaching and disclosure herein that, in various aspects, at least some of the vehicle telematics data may be collected from outside of the first vehicle 106, such as from the second vehicle 108 (e.g., by suitable wireless communication and/or data transmission from the second smart vehicle controller 122, a computing device that is traveling within the second vehicle 108 and is similar to the computing device 104, and/or from any other suitable device(s)). In aspects where at least some of the vehicle telematics data is collected from another vehicle or vehicles, such as from the second vehicle 108, the vehicle telematics data may include, for instance, GPS location, speed, heading or direction, lane, braking, cornering, acceleration, and/or route data of the other vehicle or vehicles. In further aspects, at least some of the vehicle telematics data may also or alternatively be collected from roadside infrastructure (e.g., a traffic light, a railroad crossing, etc.), and may include, for instance, telematics data associated with one or more vehicles near the roadside infrastructure; weather conditions near the roadside infrastructure; traffic and/or accident conditions near the roadside infrastructure; etc. With reference to the discussion above, alerts, warnings, recommendations, and/or other suitable feedback may be generated by, for instance, the first smart vehicle controller 120 based upon the vehicle telematics data and/or any other suitable data.

With reference to the discussion of autonomous vehicles elsewhere herein, in some aspects, a smart vehicle controller (e.g., the first smart vehicle controller 120) may determine, or perform functions associated with the determinations of, whether an anomaly such as a traffic or weather event exists and whether such an anomaly is relevant to a travel route of an autonomous vehicle (e.g., the first vehicle 106). The first smart vehicle controller 120 may perform such determinations based at least partially upon the vehicle telematics data discussed herein. In other aspects, such determinations may also or alternatively be performed by one or more other devices, such as the insurance provider server 132, based upon data including the vehicle telematics data. With reference to the disclosure elsewhere herein, determinations that an anomaly exists and that such an anomaly is relevant to a travel route of an autonomous vehicle may collectively constitute a determination that a risk of a loss associated with the party 102 is temporarily different from an ordinary risk of the loss (e.g., as described with respect to block 204 and as further described with respect to FIG. 3).

The method 300 may include determining, by the insurance provider server 132 based upon vehicle telematics data such as that discussed above, that the risk of the loss is temporarily different from the ordinary risk by determining (i) that a vehicle associated with the party 102 (e.g., the first vehicle 106) is within an area (e.g., within a geographical area of a predetermined size, such as a predetermined radius, where the predetermined size may be determined by, for instance, the insurance provider) that includes congestion, a collision, an abnormal or different collision risk, and/or a predetermined weather occurrence (e.g., a weather occurrence determined by the insurance provider, such as rain that is likely to slow travel), (ii) that the first vehicle 106 is within a predetermined distance of such congestion, collision, abnormal or different collision risk, and/or predetermined weather occurrence, and/or (iii) that the first vehicle 106 is estimated to reach the aforementioned area within a predetermined (e.g., predetermined by the insurance provider) time (block 302). With reference to the discussion with respect to block 202, in various aspects, the determination described with respect to block 302 may be based upon vehicle telematics data from the computing device 104, vehicle telematics data from the first smart vehicle controller 120, and/or vehicle telematics data and/or other data available at the insurance provider server 132.

For instance, the computing device 104 may receive vehicle telematics data including traffic and/or weather reports, and the computing device 104 may be traveling within the first vehicle 106, such as by being in the possession of the party 102 while the party 102 drives the first vehicle 106. Because the computing device 104 may be traveling within the first vehicle 106, the computing device 104 may use Global Positioning System (GPS) technology and/or other suitable technology, and/or indications regarding movement of the first vehicle 106 such as speed, a route pre-programmed into the computing device 104, and/or other vehicle telematics data to send suitable vehicle telematics data and/or other data to the insurance provider server 132 that may be used to perform at least some of the aforementioned determinations regarding congestion, a collision, an abnormal or different collision risk, and/or a predetermined weather occurrence.

Additionally or alternatively, in some aspects, the first smart vehicle controller 120 may perform one or more smart driving, control, monitoring, and/or navigation actions, and may send some or all of the data (e.g., vehicle telematics data) to the insurance provider server 132 that is described as being sent by the computing device 104. For instance, the first smart vehicle controller 120 may send location information, speed information, route information, etc. to the insurance provider server 132. Additionally or alternatively, in some aspects, data regarding collisions, traffic, and/or weather may be stored at and/or accessible to the insurance provider server 132. In some aspects, the computing device 104 may also or alternatively execute a mobile application or “app” (e.g., the telematics app discussed elsewhere herein) that may, for example, send location and speed information to the insurance provider server 132. Additionally or alternatively, in some aspects, the second smart vehicle controller 122 of the second vehicle 108 (where the second vehicle 108 may be associated with another party (the other party not being shown in FIG. 1)) may send traffic, weather, and/or collision data to the insurance provider server 132 for use in performance of at least some of the aforementioned determinations regarding congestion, a collision, an abnormal or different collision risk, and/or a predetermined weather occurrence. In still other aspects, the second smart vehicle controller 122 of the second vehicle 108 may send such data to the first smart vehicle controller 120 and/or the computing device 104, and the first smart vehicle controller 120 and/or the computing device 104 may send such data to the insurance provider server 132 along with any traffic, weather, collision, speed, and/or location data collected and/or generated by the first smart vehicle controller 120 and/or the computing device 104.

As further described herein, determining the one or more terms of the temporary insurance coverage may be performed based upon the type of the loss for which the risk is temporarily different from the ordinary risk of the loss. Additionally, as further described herein, determining the one or more terms of the temporary insurance coverage may include determining a type or types of the temporary insurance coverage, such as liability insurance coverage and/or automotive insurance coverage in one or more of the scenarios discussed with respect to block 302.

The method 300 may include determining, by the insurance provider server 132 based upon the data indicative of the risk of the loss associated with the party 102, that the risk of the loss is temporarily different from the ordinary risk by determining that the dog 128 or other animal associated with (e.g., owned by) the party 102 is present within the first vehicle 106 (block 304). As with the determination described with respect to block 302, the determination described with respect to block 304 may be based upon data from the computing device 104, data from the first smart vehicle controller 120, and/or data available at the insurance provider server 132. For instance, the party 102 may use the computing device 104 and/or the first smart vehicle controller 120 to communicate an indication to the insurance provider server 132 that the dog 128 is present within (e.g., traveling in) the first vehicle 106, and the indication communicated to the insurance provider server 132 may constitute all or part of the data indicative of the risk of the loss associated with the party 102.

In other aspects, the insurance provider server 132 may also or alternatively determine that the dog 128 is present within the first vehicle 106, such as based upon historical travel data. For example, if the computing device 104 and/or the first smart vehicle controller 120 indicates a route and/or destination that the insurance provider server 132 associates with the dog 128 (e.g., based upon a previously received indication(s) that the dog 128 has traveled the indicated route and/or to the indicated destination), the insurance provider server 132 may send a message to the computing device 104 to confirm that the dog 128 is within the first vehicle 106. As discussed elsewhere herein, the type of temporary insurance coverage may include pet insurance, and pet insurance may be offered, provided, etc. to the party 102 upon a determination that the dog 128 is within the first vehicle 106.

The method 300 may include determining, by the insurance provider server 132 based upon the data indicative of the risk of the loss associated with the party 102, that the risk of the loss is temporarily different from the ordinary risk by determining that the party 102 is riding the bicycle 114 (block 306). In various aspects, the determination described with respect to block 306 may be based upon data from the computing device 104 and/or data available at the insurance provider server 132. For instance, the computing device 104 may communicate an indication or indications of locations of the party 102 (e.g., automatically, in response to the party selecting an option to enable such functionality such as via an app provided by the insurance provider, etc.). The location information may be used by the insurance provider server 132 in conjunction with time information available at the insurance provider server 132 to determine a speed at which the computing device 104 is moving, and therefore a speed at which the party 102 is assumed to be moving.

In an aspect, if the speed at which the computing device 104 is determined to be moving is too slow to assume the computing device 104 is moving within an automobile, but too fast to assume the computing device 104 is moving at a walking pace, then it may be assumed that the party 102 is riding a bicycle such as the bicycle 114. For instance, if it is determined that the computing device 104 is moving at ten miles per hour (10 mph), or at a speed within a suitable range determined by the insurance provider that includes ten miles per hour or any other suitable speed(s), then it may be determined that the party 102 is riding the bicycle 114. In other aspects, the party 102 may communicate to the insurance provider 132, such as using the computing device 104 via the network 130, that the party 102 will be riding the bicycle 114 during a particular interval of time, or a service provider that provides the bicycle 114 to the party 102 for rent may communicate such information from the service provider server 140 to the insurance provider server 132 (e.g., with prior consent of the party 102). As discussed elsewhere herein, the type of temporary insurance coverage may include liability insurance, life insurance coverage, insurance coverage covering personal injury associated with the party 102, insurance coverage covering damage to and/or theft of property, etc., and one or more such types of insurance may be offered, provided, etc. to the party 102 upon a determination that the party 102 is riding the bicycle 114.

The method 300 may include determining, by the insurance provider server 132, habit data of the party 102 based upon previous activity data corresponding to previous activity of the party 102 (block 308). The previous activity data corresponding to the previous activity of the party 102 may be or may be included within the data indicative of the risk of the loss associated with the party 102. In some aspects, the previous activity data may include previous driving data of the party 102, which may be collected by the computing device 104 (e.g., while executing an app provided by the insurance provider), by the first smart vehicle controller 120, or any suitable device, and which may be transmitted to the insurance provider server 132. For example, the previous activity data may indicate speeds at which the party 102 has previously driven (or operated, such as in the case of an autonomous or semi-autonomous vehicle) the first vehicle 106 on certain roads (e.g., along a particular route or routes), or any suitable data regarding previous activity or activities of the party 102 that may be useful to the insurance provider 132 in determining the habit data of the party 102, where the habit data may be indicative of at least one habit of the party 102. The habit data may be, for example, data indicating that the party 102 generally drives above or below (or otherwise deviates from) the speed limit on a certain section of road, or any data useful in predicting whether a risk of a loss associated with the party 102 is temporarily higher (or lower, or otherwise different) than normal.

The method 300 may include determining, by the insurance provider server 132, based upon the habit data, whether the risk of the loss associated with the party 102 is temporarily higher (or lower, or otherwise different) than the ordinary risk of the loss (block 310). For example, the habit data may indicate that the party 102 has a habit of deviating from the speed limit on a certain section of road (e.g., that the party 102 speeds on the certain section of road at least a predetermined percentage of the time that the party 102 drives on the certain section of road, and/or operates an autonomous vehicle at speeds that deviate from posted speed limits). In this example, if location and/or route data of the party 102 (e.g., as provided by the computing device 104) indicates that the party 102 and/or an associated autonomous vehicle (e.g., an autonomous vehicle operated by or otherwise being utilized by the party 102) is on or expected to be on the certain section of road within a predetermined amount of time, then it may be determined that the risk of the loss associated with the party 102 and/or the associated autonomous vehicle is temporarily different from the ordinary risk. Terms of temporary insurance coverage may then be determined and such temporary insurance coverage may be offered, provided, etc. to the party 102 or autonomous vehicle (covering the party 102, passengers, and/or autonomous vehicle, for example), as described elsewhere herein.

The method 300 may include determining, by the insurance provider server 132 based upon the data indicative of the risk of the loss associated with the party 102, that the risk of the loss is temporarily higher (or lower, or otherwise different) than the ordinary risk by determining that the party 102 is at least one of traveling using a travel service or expected to travel using the travel service within a predetermined (e.g., by the insurance provider server 132) amount of time (block 312). Such a determination may be made based upon travel information of the party 102 that the party 102 provides using, for example, the computing device 104; travel information of the party 102 that is made available to the insurance provider server 132 from, for instance, the travel service server 138 (e.g., with prior consent of the party 102), or in any suitable manner. Additionally or alternatively, in other aspects, some or all of the travel information of the party 102 may be available at the insurance provider server 132 without being received from the computing device 104 or the travel service server 138 (e.g., the party 102 may have provided such information via a website of the insurance provider, at an office of the insurance provider, over the phone to the insurance provider, etc.). It should be appreciated from the teaching and disclosure herein that the travel information of the party 102 that forms the basis of the determination that the risk of the loss associated with the party 102 is temporarily higher (or lower, or otherwise different, respectively) than the ordinary risk may be or may be included within the data indicative of the risk of the loss associated with the party 102.

In some aspects, it may be determined that the risk of the loss associated with the party 102 is temporarily higher than (or alternatively, lower than, or different or deviates from) the ordinary risk by determining that the party 102 is traveling and/or expected to travel using a travel service because of risks inherent in travel (e.g., airline delays that may cause the party 102 to, for example, miss an event that the party 102 paid to attend, such as a conference; the possibility of a crash of the airplane 118 that the party 102 may use in travel, or the possibility or possibilities of another type(s) of accident(s) during travel; the possibility of the party 102 becoming sick from fellow passengers during travel and subsequently suffering loss of enjoyment of, for instance, a vacation; etc.). Additionally or alternatively, in some aspects, it may be determined that the risk of the loss associated with the party 102 is temporarily higher than (or alternatively, lower than or otherwise deviates from) the ordinary risk because of the type of travel (e.g., travel in a hot air balloon); because of items brought with the party 102 during travel (or planned to be brought with the party 102) such as luggage, where the party 102 may, for instance, use an app executed by the computing device 104 to inform the insurance provider that the party 102 will be traveling with such items; etc. The one or more terms of the temporary insurance coverage, such as but not limited to the type of the temporary insurance coverage, may be determined accordingly and such temporary insurance coverage may be offered to and/or provided to the party 102 as described elsewhere herein.

The method 300 may include determining, by the insurance provider server 132 based upon the data indicative of the risk of the loss associated with the party 102, that the risk of the loss is temporarily higher than (or alternatively, lower than or otherwise deviates from) the ordinary risk based upon determining a location of the party 102 and/or an expected future location of the party 102 (block 314). In some aspects, the location of the party 102 may be determined based upon GPS information or other location information received by the insurance provider server 132 from the computing device 104. Additionally or alternatively, in some aspects, the expected future location of the party 102 may be determined based upon GPS information or other location information received by the insurance provider server 132 from the computing device in conjunction with, for instance, speed information, route information, and/or other suitable vehicle telematics information, etc. corresponding to the party 102.

In some aspects, the insurance provider server 132 may determine that the risk of the loss is temporarily different from ordinary based upon the determined location and/or expected location of the party 102 when the location and/or expected location includes and/or is within a high-crime area; an area where fraud has occurred at a high rate and/or recently, such as at a threshold rate and/or within a predetermined period of time set by the insurance provider (e.g., fraud in one or more transactions with one or more merchants, including transactions involving parties other than the party 102 who have reported such fraud to the insurance provider either directly or indirectly); an area with natural hazards (e.g., a national park area with multiple bodies of water and/or where activities such as climbing may take place, which could lead to loss of personal property such as a mobile phone); an area with a high rate of automobile or other accidents (e.g., collisions) (e.g., as determined by a historical map and/or other record of such accidents); an area with a high number of recent burglaries; an area with recent reported civil unrest, protests; an area recently affected by and/or determined to be at increased likelihood (e.g., based upon data collected by and/or provided to the insurance provider server 132) of food poisoning, illness due to water supply issues, product recalls, etc.; and/or any other suitable location and/or expected location.

In some aspects, the determination that the risk of the loss is temporarily different from ordinary may be further based upon how long the party 102 has indicated to, for instance, the insurance provider server 132 that the party 102 will be at the determined location and/or expected location; the type of accommodations the party 102 has indicated to the insurance provider server 132 that the party 102 will use (e.g., having to sleep in the first vehicle 106 of the party 102 because of civil unrest versus staying in a hotel such as the hotel 116, etc.). Such indications to the insurance provider server 132 and to the insurance provider in general may be made with the permission or affirmative consent of the party 102 to such indications being made available to facilitate the offering and/or providing of temporary insurance coverage.

In some aspects, data such as crime history, national park or other natural hazard location(s), accident (e.g., collision) history, etc. may be provided to the insurance provider server 132 by appropriate entities, authorities, and/or parties (which may include the party 102) having insurance coverage through the insurance provider. Additionally or alternatively, in some aspects, such data may be collected by the insurance provider server 132 from such appropriate entities, authorities, and/or insured parties (e.g., from insured parties during claim filing processes). The one or more terms of the temporary insurance coverage, such as but not limited to the type of the temporary insurance coverage, may be determined based upon the location and/or the expected location and/or the reason(s) (e.g., location within a high-crime area) that the location and/or the expected location cause the risk of the loss associated with the party 102 to be temporarily different from ordinary, and the temporary insurance coverage may be offered to and/or provided to the party 102 as described elsewhere herein.

The method 300 may include determining, by the insurance provider server 132 based upon the data indicative of the risk of the loss associated with the party 102, that the risk of the loss is temporarily higher than (or otherwise deviates from) the ordinary risk by determining that a rating associated with a service provider that is currently providing a service to the party 102 or that is expected to provide a service to the party 102 within a predetermined amount of time is at or below a predetermined level (e.g., a level determined by the insurance provider) (block 316). For instance, the insured party 102 may request on-demand transportation from a service provider by connecting via a suitable app to the service provider server 140, and the service provider server 140 and/or the rating server 142 may indicate a rating associated with, for instance, a driver that the service provider assigns to fulfill the request of the party 102. The rating may be sent to the computing device 104 of the party, and with, for instance, prior consent of the party 102, the rating may be sent to the insurance provider server 132 from the computing device 104. In other aspects, the party 102 may indicate to the insurance provider server 132 (e.g., via the computing device 104) a particular service provider from which a service has been requested, and the insurance provider server 132 may obtain a rating of the service provider from the service provider server 140 and/or the rating server 142 (e.g., with prior consent of the party 102). The one or more terms of temporary insurance coverage, including one or more types of temporary insurance coverage, may be determined based upon factors such as the rating and the type of service the party 102 has requested.

The method 300 may include determining, by the insurance provider server 132 based upon the data indicative of the risk of the loss associated with the party 102, that the risk of the loss is temporarily higher than (or otherwise deviates from) the ordinary risk by determining that the party 102 is currently engaged in, or is expected to engage in, a transaction with another party and that the other party has an associated risk of a fraudulent transaction that is higher than a predetermined risk (e.g., a risk set by the insurance provider) (block 318). For example, the other party may be a merchant with respect to which a predetermined number or percentage of incidents of fraud have been reported to the insurance provider, such as fraud by the merchant or fraud by a known or unknown third party when transacting with the merchant (e.g., when transacting via a website of the merchant).

In one aspect, the determination that the party 102 is currently engaged in such a transaction may be made by an app provided by the insurance provider and executing on the computing device 104 detecting that the computing device 104 is being used to engage in a transaction with the other party (e.g., merchant). In another aspect, the determination that the party 102 is currently engaged in a transaction with another party that has a higher associated risk of a fraudulent transaction may be made based upon the party 102 inputting data into the computing device 104 indicating that the party 102 is engaging in a transaction with the other party, and the insurance provider 132 may access historical information (e.g., reports of associated fraud) associated with the other party to perform the determination. In yet another aspect, the determination that the party 102 is expected to engage in a transaction with another party that has a higher associated risk of a fraudulent transaction may be made based upon an app provided by the insurance provider and executing on the computing device 104 detecting that the computing device 104 is being used to shop on the other party's website; based upon the computing device 104 sending location information to the insurance provider server 132 and the insurance provider 132 associating the location of the computing device 104 (and thereby an assumed location of the party 102) with a historical rate or level of fraudulent transactions that is higher than (or otherwise deviates from) a predetermined rate or level; etc. In another aspect, the determination that the party 102 is expected to engage in a transaction with another party that has a higher associated risk of a fraudulent transaction may be made based upon one or more factors that are independent of the other party. For instance, the insurance provider server 132 may determine that the party 102 is expected to engage in a transaction in a high-fraud location and/or period of time, such as during the winter holiday season or any other holiday season or holiday (e.g., Mardi Gras), during a large event such as an industry conference, during and/or near a location of a new product release (e.g., at or near a store where such a new product is being sold), etc.

It should be understood in light of the teaching and disclosure herein that one or more of the actions described with respect to blocks 302-318 may constitute all or part of the performance of the actions described with respect to block 204 of FIG. 2 to determine that a risk of a loss associated with the party 102 is temporarily higher than (or lower than, or otherwise is different from) an ordinary, average, or baseline risk of the loss. Moreover, it should be understood in light of the teaching and disclosure herein that one or more of the actions described with respect to blocks 302-318 need not be performed. For instance, in some aspects, once a risk of a loss associated with the party 102 is determined to be temporarily higher than (or lower than, or different from, respectively) the ordinary risk of the loss, the method 300 may proceed, as discussed below, to performance of the actions described with respect to block 206 in order to determine the one or more terms of the temporary insurance coverage as further discussed above with respect to block 206.

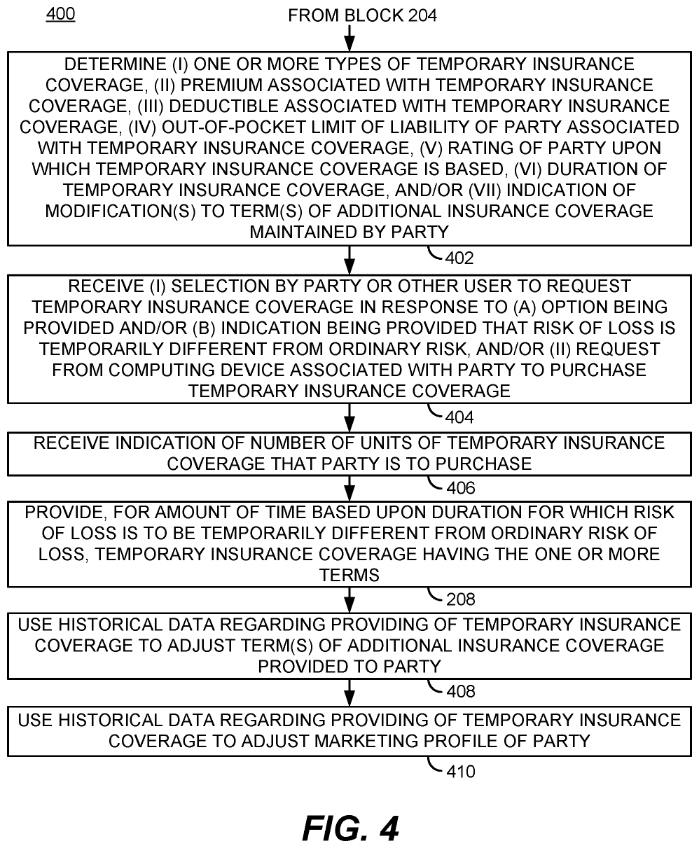

The method 300 may include performing the actions described with respect to blocks 206 and 208 to determine the one or more terms associated with the temporary insurance coverage and to provide the temporary insurance coverage, as further discussed with respect to, for example, FIGS. 2 and 4.

The method 300 may include additional, less, or alternate actions, including those discussed elsewhere herein, and/or may be implemented via an appropriate computing device(s) and/or processors thereof (e.g., the insurance provider server 132), or via computer-executable instructions stored on non-transitory computer-readable medium or media.

FIG. 4 illustrates another exemplary computer-implemented method 400 of providing insurance coverage using temporary risk data, in accordance with another exemplary aspect of the present disclosure. In one aspect, the method 400 may be implemented by the insurance provider server 132. For instance, the method 400 may be performed by one or more processors, applications, and/or routines that are part of, stored by, and/or otherwise accessible to the insurance provider server 132. It will be appreciated from the teaching and disclosure herein that the method 400 may include a more particular implementation(s) of aspects of the method 200.

The method 400 may include performing the actions described with respect to blocks 202 and 204 in order to receive the data indicative of the risk of the loss associated with the party 102 (block 202) and determine whether the risk of the loss associated with the party 102 is temporarily higher than (or alternatively, lower than or otherwise deviates from) an ordinary, average, or baseline level of risk of the loss (block 204).

The method 400 may also include determining, by the insurance provider server 132, one or more terms of temporary insurance coverage for the loss having the risk that is temporarily higher (or lower, or otherwise different) than ordinary, including determining (i) one or more types of the temporary insurance coverage, (ii) a premium associated with the temporary insurance coverage, (iii) a deductible associated with the temporary insurance coverage, (iv) an out-of-pocket limit of liability of the party 102 associated with the temporary insurance coverage, (v) a rating of the party 102 upon which the temporary insurance coverage is based, (vi) a duration of the temporary insurance coverage, and/or (vii) an indication of one or more modifications to one or more terms of additional insurance coverage maintained by the party 102 (e.g., a modification(s) to the additional insurance coverage that is/are to be made effective by the providing of the temporary insurance coverage) (block 402).

It should be appreciated that the actions described with respect to block 402 may be an implementation of the actions described above with respect to block 206. As such, the determination(s) described with respect to block 402 may be based upon, for example, an amount by which the risk of the loss is temporarily higher (lower, or different, respectively) than the ordinary risk of the loss; a duration for which the risk of the loss is to be temporarily higher (lower, or different, respectively) than the ordinary risk of the loss; a type of the loss for which the risk is temporarily higher (lower, or different, respectively) than the ordinary risk; one or more attributes of the party 102; one or more selections made by the party 102 (e.g., using the computing device 104) that are communicated to the insurance provider server 132; and/or any other suitable factors.

In various aspects, the one or more attributes of the party 102 may include an occupation of the party 102; at least one asset associated with the party 102; and/or a location of the party 102. For instance, if the party 102 is a police officer, firefighter, paramedic, etc. in a location where an event (e.g., a crime, a fire, etc.) is occurring and to which the party 102 is responding, the occupation of the party 102 as a police officer, firefighter, paramedic, etc. may be a basis for determining one or more terms such as a deductible or a premium, etc., associated with the temporary insurance coverage. As another example, if the party 102 is an owner of the hotel 116, an employee of the hotel 116, or otherwise associated with the hotel 116 and/or any other building or asset (not shown in FIG. 1) near which civil unrest or an ongoing crime has been reported, the term or terms of the temporary insurance coverage offered to and/or provided to the party 102 may be based upon the asset (e.g., the hotel 116) associated with the party 102 and/or the nature of the association of the party 102 with the asset (e.g., owner, non-owner in vicinity of asset, guest at asset (e.g., guest at hotel 116), etc.).

In various aspects, the one or more types of the temporary insurance coverage may include liability insurance coverage, insurance coverage covering loss to and/or damage of property; insurance coverage covering loss of use of property; insurance coverage covering theft of property; insurance coverage covering personal injury associated with (e.g., sustained by) the party 102; insurance coverage that provides fraud protection to the party 102; business insurance coverage; life and/or health insurance coverage; pet insurance coverage; travel insurance coverage; automotive insurance coverage; litigation insurance coverage; and/or any other suitable type(s) of insurance coverage. In some aspects, litigation insurance may be offered to and/or provided to the party 102 when the party 102 is in an area where the party 102 is susceptible to food poisoning and/or an area with a product recall(s), as discussed above, particularly when the party 102 indicates via the computing device 104—either automatically such as by transaction detection or by manual input—to the insurance provider 132 that the party 102 has purchased a product that is or may be subject to a recall. In some aspects, the litigation insurance may be priced according to a percentage of any potential settlement and/or other winnings that the party 102 agrees to share with the insurance provider. Additionally or alternatively, in some aspects, business insurance (including, in some instances, liability insurance) may be offered to and/or provided to the party 102 that covers one or more of inventory loss, retail theft, looting, vandalism, general business loss, etc. Generally speaking, any of the types of insurance discussed herein may be provided to the party 102 on a temporary basis as all or part of the temporary insurance coverage in any desired and/or suitable manner. The party 102 may, in some instances, request certain attributes and/or terms of the temporary insurance coverage from the insurance provider server 132 via, for example, the computing device 104, and a term or terms of the temporary insurance coverage (e.g., premium, deductible, duration, etc.) may be adjusted by the insurance provider accordingly if the insurance provider grants the request of the party 102.

In aspects where the one or more determined terms of the temporary insurance coverage include an indication of one or more modifications to one or more terms of additional insurance coverage maintained by the party 102, the additional insurance coverage maintained by the party 102 may include longer-duration insurance coverage for the loss having the risk that is higher (or otherwise different) than the ordinary risk of the loss. In some aspects, the longer-duration insurance coverage may be insurance coverage for a duration that is (i) at least a predetermined duration (e.g., at least a duration determined by the insurance provider), and/or (ii) a duration longer than the amount of time for which the temporary insurance coverage is to be provided. In some aspects, the one or more modifications to the one or more terms of the additional (e.g., longer-duration) insurance coverage may include (i) a reduction (or elimination) of a deductible associated with the longer-duration insurance coverage, (ii) an amount of time for which the reduction or elimination of the deductible associated with the longer-duration insurance coverage is effective, (iii) a reduction (or elimination) of an out-of-pocket limit of liability of the party 102 associated with (e.g., maintaining) the longer-duration insurance coverage, and/or (iv) an amount of time for which the reduction or elimination of the out-of-pocket limit of liability of the party 102 associated with the longer-duration insurance coverage is effective.

The method 400 may include receiving, by the insurance provider server 132, (i) a selection by the party 102 or another user associated with the party 102 (e.g., a fellow passenger in an automobile driven by the party 102) to request the temporary insurance coverage in response to (a) an option being provided, based upon the determining that the risk of the loss is temporarily higher (or alternatively different) than the ordinary risk of the loss, to the party 102 or the other user associated with the party 102 (e.g., via a user interface of the computing device 104) to request the temporary insurance coverage, and/or (b) an indication being provided, based upon the determining that the risk of the loss is temporarily higher (or alternatively different) than the ordinary risk of the loss, to the party 102 or the other user associated with the party 102 (e.g., via a user interface of the computing device 104) that the risk of the loss is temporarily higher (or alternatively different) than the ordinary risk of the loss, and/or (ii) a request from the computing device 104 to purchase the temporary insurance coverage (block 404).

In some aspects, the request from the computing device 104 to purchase the temporary insurance coverage may be sent and received automatically at the insurance provider server 132 based upon the determining that the risk of the loss is temporarily higher (or alternatively different) than the ordinary risk of the loss and the insurance provider 132 communicating this determination to the computing device 104. For instance, the party 102 may have previously selected an option for the computing device 104 to automatically request to purchase the temporary insurance coverage when a determination that a risk of a loss associated with the party 102 is temporarily higher (or alternatively different) than ordinary is made. In some aspects, providing the temporary insurance coverage as described with respect to block 208 may be performed in response to receiving (i) the selection by the party 102 or the other user associated with the party 102 to request the temporary insurance coverage, and/or (ii) the request that is received automatically from the computing device 104.

The method 400 may include receiving, by the insurance provider server 132, an indication from the party 102 and/or the computing device 104 of a number of “units” of the temporary insurance coverage that the party 102 is to purchase (block 406). In various aspects, one unit of temporary insurance coverage may correspond to one or more types of temporary insurance coverage (e.g., life insurance, liability insurance, etc.), a monetary amount associated with the temporary insurance coverage (e.g., coverage for losses up to a certain dollar amount), a duration of the temporary insurance coverage (e.g., a number of minutes, hours, days, weeks, etc. of coverage), and/or an indication of one or more modifications to one or more terms of additional (e.g., longer-duration) insurance coverage maintained by the party 102. As an example, one unit of temporary life insurance coverage may correspond to life insurance coverage with a payout amount of $50,000.00 in addition to the payout amount of any longer-duration insurance coverage maintained by the party 102, where the temporary life insurance coverage may be effective for 12 hours. Numerous other examples are envisioned with any suitable and/or desired attributes corresponding to or defining a “unit” of temporary insurance coverage.

The method 400 may include performing the actions described with respect to block 208 to provide the temporary insurance coverage to the party 102. The method 400 may also include using, by the insurance provider server 132, historical data regarding the providing of the temporary insurance coverage to the party 102 to adjust one or more terms of additional (e.g., longer-duration) insurance coverage provided to the party 102 by the insurance provider (block 408). For instance, the insurance provider server 132 may utilize data regarding the duration for which the temporary insurance coverage is or was provided, the type of loss for which the risk was temporarily different from the ordinary risk, and/or other suitable historical data to change (e.g., adjust) a term or terms (e.g., a deductible, a premium, etc.) of longer-duration insurance coverage. Thus, if the party 102 repeatedly utilizes temporary insurance coverage with respect to a particular type of loss and/or is repeatedly at a threshold level or lower (or alternatively, higher) of risk of the particular type of loss, the deductible and/or the premium of the longer-duration insurance coverage provided to the party for the same type of loss (and in some cases, for other types of losses), among other terms of the longer-duration insurance coverage, may decrease or otherwise change accordingly.

The method 400 may include using, by the insurance provider server 132, historical data regarding the providing of the temporary insurance coverage to the party 102 to adjust a marketing profile of the party 102 (block 410). The marketing profile of the party 102 may be used to (i) offer goods and/or services sold by the insurance provider 132 to the party (e.g., one or more types of longer-duration insurance), and/or (ii) offer goods and/or services to the party 102 that are sold by an entity with which the insurance provider partners. For instance, at least a portion of the marketing profile of the party 102 may be sent from the insurance provider server 132 to the partner server 136, where the at least the portion of the marketing profile of the party 102 may indicate that the party 102 has been provided with temporary insurance coverage covering personal injury to the party 102 on multiple occasions when the party 102 has been determined to be riding the bicycle 114, as discussed above. The partner of the insurance provider in this example may sell bicycling accessories, and in response to the receipt of the at least the portion of the marketing profile of the party 102 at the partner server 136, information regarding an offer (e.g., with a discount) of a sale of a bicycle helmet and/or other bicycling accessories may be sent from the partner server 136 to the insurance provider server 132 for providing to the computing device 104 and presentation via a user interface to the party 102.

The method 400 may include additional, less, or alternate actions, including those discussed elsewhere herein, and/or may be implemented via an appropriate computing device(s) and/or processors thereof (e.g., the insurance provider server 132), or via computer-executable instructions stored on non-transitory computer-readable medium or media.

Exemplary Providing of Insurance Coverage Using Temporary Risk Data Determined Using Devices Associated with a Party

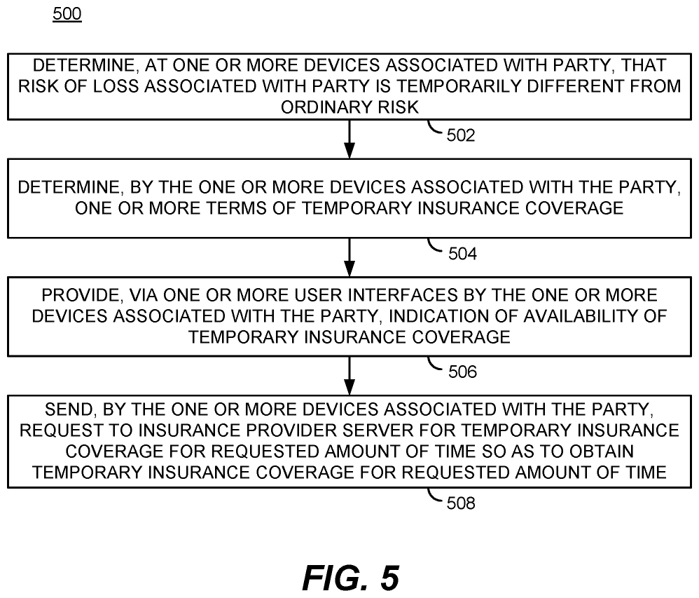

FIG. 5 illustrates an exemplary computer-implemented method 500 of providing insurance coverage using temporary risk data determined using one or more devices associated with a party (e.g., the party 102), in accordance with an exemplary aspect of the present disclosure. In one aspect, the method 500 may be implemented by one or more devices associated with the party 102, such as the computing device 104, the first smart vehicle controller 120, the first smart home device 124, and/or any suitable device(s) associated with the party 102 (including a device(s) that generate vehicle sensor data, smart vehicle controller data, autonomous vehicle data, vehicle telematics data, smart or intelligent telematics or other data, etc.). For instance, the method 500 may be performed by one or more processors, applications, and/or routines that are part of, stored by, and/or otherwise accessible to the computing device 104, the first smart vehicle controller 120, and/or the first smart home device 124.

The method 500 may include determining, at the one or more devices associated with the party 102 (e.g., the computing device 104, the first smart vehicle controller 120, and/or the first smart home device 124), by at least one of (i) one or more processors or (ii) one or more transceivers of the one or more devices associated with the party 102, that a risk of a loss associated with the party 102 is temporarily higher (or lower, or otherwise different) than an ordinary risk of the loss (block 502). The determination described with respect to block 502 may be performed in a similar manner as that described with respect to block 204, except that the determination described with respect to block 502 may be performed by the one or more devices associated with the party 102 instead of being performed by the insurance provider server 132. In some aspects, the risk of the loss associated with the party 102 may be temporarily higher (or lower, or different) than the ordinary risk of the loss when the risk of the loss is higher (or lower, or different, respectively) than the ordinary risk of the loss for the same or similar amounts of time as described with respect to block 204, or for any other suitable amount of time determined by, for example, the party 102 and/or the one or more devices associated with the party 102.

The method 500 may include determining, by the one or more devices associated with the party 102, one or more terms of temporary insurance coverage for the loss having the risk that is temporarily higher (or lower, or different) than the ordinary risk of the loss (block 504). The determination described with respect to block 504 may be performed in a similar manner and/or based upon the same or similar factors as described with respect to block 206, except that the determination described with respect to block 504 may be performed by the one or more devices associated with the party 102 instead of being performed by the insurance provider server 132.

The method 500 may include providing, via one or more user interfaces by one or more processors of the one or more devices associated with the party 102, an indication of an availability of the temporary insurance coverage (block 506), which may include increased or reduced levels of insurance coverage, or otherwise different insurance coverage (e.g., different terms of insurance coverage). With reference to the discussion above, in various aspects, the indication of the availability of the temporary insurance coverage may be provided as a selectable option to request the temporary insurance coverage (which option may include the one or more determined terms of the temporary insurance coverage, or which option, when selected, may display the one or more determined terms, etc.); as an indication that the risk of the loss associated with the party 102 is temporarily higher (or lower, or different) than ordinary; and/or as any other suitable indication.

The method 500 may include sending, by the one or more devices associated with the party 102, a request to the insurance provider server 132 for the temporary insurance coverage for a requested amount of time so as to obtain the temporary insurance coverage for the requested amount of time (block 508). In some aspects, the requested amount of time may be a determined duration of the temporary insurance coverage that has been determined as a term of the temporary insurance coverage, such as in performing the actions described with respect to block 504. In other aspects, the requested amount of time may be based upon a duration for which the risk of the loss is to be temporarily higher (or lower, or different, respectively) than ordinary (e.g., as determined by the one or more devices associated with the party 102).

It should be appreciated in light of the teaching and disclosure herein that the functionality described with respect to the method 500 and the one or more devices associated with the party 102 may be at least partially provided by, for example, a mobile app and/or other software provided by the insurance provider and executing on the one or more devices associated with the party 102.

The method 500 may include additional, less, or alternate actions, including those discussed elsewhere herein, and/or may be implemented via an appropriate computing device(s) and/or processors thereof (e.g., the computing device 104, the first smart vehicle controller 120, the first smart or intelligent home controller 123, and/or the first smart home device 124, etc.), or via computer-executable instructions stored on non-transitory computer-readable medium or media.

Additional Exemplary Aspects Relating to Providing of Insurance Coverage Using Temporary Risk Data Determined Using One or More Devices Associated with a Party

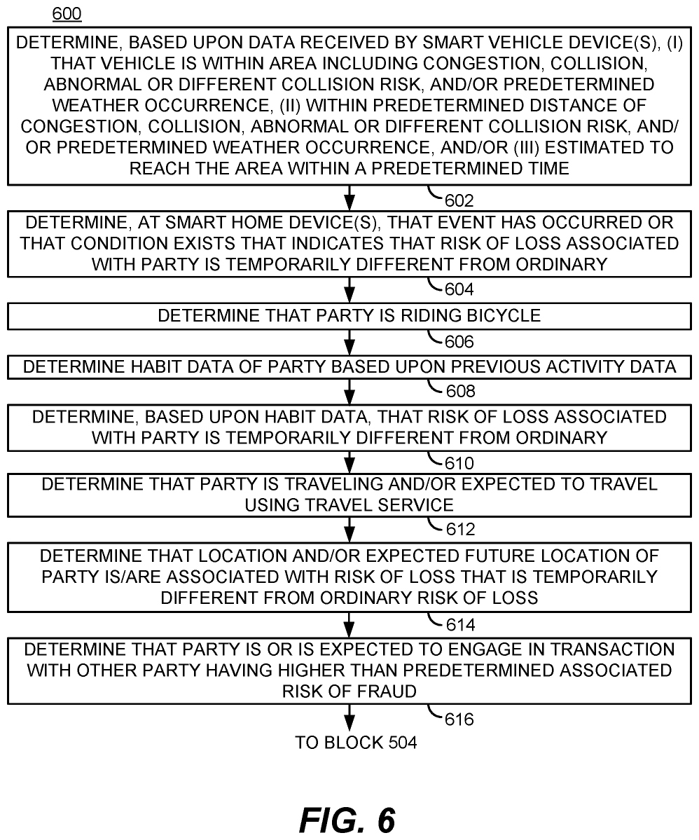

FIG. 6 illustrates another exemplary computer-implemented method 600 of providing insurance coverage using temporary risk data determined using one or more devices associated with the party 102, in accordance with another exemplary aspect of the present disclosure. In one aspect, the method 600 may be implemented by the computing device 104, the first smart vehicle controller 120, the first smart or intelligent home controller 123, and/or the first smart home device 124. For instance, the method 600 may be performed by one or more processors, applications, and/or routines that are part of, stored by, and/or otherwise accessible to the computing device 104, the first smart vehicle controller 120, the first smart or intelligent home controller 123, and/or the first smart home device 124. It will be appreciated from the teaching and disclosure herein that the method 600 may include a more particular implementation(s) of aspects of the method 500.

The method 600 may include determining, at the one or more devices associated with the party 102, which may be one or more smart vehicle controllers associated with a vehicle in which the party 102 travels (e.g., drives, or rides along in an autonomous vehicle), such as the first smart vehicle controller 120 associated with the first vehicle 106, based upon data received by the one or more smart vehicle controllers from one or more additional smart vehicle controllers (e.g., the second smart vehicle controller 122), that (i) the first vehicle 106 is within an area that includes congestion, a collision, an abnormal or different collision risk, and/or a predetermined weather occurrence, (ii) that the first vehicle 106 is within a predetermined distance of such congestion, collision, abnormal or different collision risk, and/or predetermined weather occurrence, and/or (iii) that the first vehicle 106 is estimated to reach the aforementioned area within a predetermined (e.g., predetermined by the first smart vehicle controller 120) time (block 602).

The determination described with respect to block 602 may be performed in a similar manner as that described with respect to block 302, except that the determination may be performed at the one or more smart (including autonomous) vehicle devices based upon data received from the one or more additional smart (including autonomous) vehicle devices. For instance, the second smart vehicle controller 122 may communicate, directly or via the network 130, with the first smart vehicle controller 120 to indicate congestion, a collision, a predetermined weather occurrence, etc. at a particular location.

The method 600 may include determining, at the one or more devices associated with the party 102, which may be one or more smart home devices associated with a residence in which the party 102 lives (e.g., the first smart home device 124 associated with the first residence 110, which may facilitate automatic control and/or monitoring functions at the first residence 110), that an event has occurred or that a condition exists that indicates that a risk of a loss associated with the party 102 is temporarily different from an ordinary risk of such loss (block 604).

In various aspects, the first smart home device 124 associated with the first residence 110 may generate smart or intelligent home telematics data that may be specific to the type of the first smart home device 124. For instance, in an example in which the first smart home device 124 is, is included within, or includes a home security system or device, the first smart home device 124 may generate intelligent home telematics data that includes data corresponding to images of interior and/or exterior portions of the first residence 110; indications of whether one or more doors of the first residence 110 are opened; one or more alarms (e.g., alarms which may be provided to the party 102 and/or to a police department for appropriate response) when, for instance, a door of the first residence 110 is opened while the home security system or device is set to an overnight monitoring mode during which no lawful occupant of the first residence 110 is expected to enter or exit the first residence 110; a history of entries and/or exits from the first residence 110 as indicated by openings of doors; and/or any other suitable data.

In other aspects, the first smart home device 124 may be, may be included within, or may include any other suitable system or device that generates intelligent home telematics data. For instance, the first smart home device 124 may be, may be included within, or may include a smart fire alarm; a smart sump pump; a smart thermostat; a smart door and/or smart door lock; a smart light switch; a smart washer; a smart oven; and/or any other suitable smart system or device. In various aspects, such smart systems or devices may generate intelligent home telematics data such as an indication that smoke has been detected in the first residence 110; an indication of one or more temperatures of one or more rooms of the first residence 110; an indication of whether one or more cooling and/or heating systems and/or devices of the first residence 110 are turned on or off; an indication of one or more desired temperatures of one or more rooms of the first residence 110; an indication of whether a door of the first residence 110 is opened and/or unlocked; an indication of whether a light within the first residence 110 is turned on; and/or an indication of any other suitable condition and/or event associated with the first residence 110.

Additionally or alternatively, in some aspects, the first smart home device 124 may collect, such as via one or more processors, intelligent home telematics data from one or more other devices (e.g., other smart home devices). The one or more other smart home devices may be located at or within the first residence 110, or may be located remotely from the first residence 110, such as at the second residence 112 in the case of the second smart home device 126 and/or at one or more other residences. In any event, the one or more other smart home devices may generate intelligent home telematics data that may be collected (e.g., via the network 130) by the first smart home device 124 for use in determining that an event has occurred or that a condition exists that is indicative that a risk of a loss associated with the party 102 is temporarily different from an ordinary risk of such loss.

In some aspects, the first smart home device 124 may operate in conjunction with the first smart or intelligent home controller 123, and the first smart or intelligent home controller 123 may receive intelligent home telematics data from the first smart home device 124 and/or other devices (e.g., the second smart home device 126 and/or other devices discussed herein). The first smart or intelligent home controller 123 may also or alternatively communicate intelligent home telematics data between devices, such as between smart home devices; determine when a condition or event exists or has occurred that is to result in an alarm or other notification being generated; cause one or more smart home devices to generate such an alarm or other notification; and/or perform any other suitable actions. Additionally or alternatively, one or more smart home devices (e.g., the first smart home device 124) may perform one or more of the functions described with respect to the first smart or intelligent home controller 123 (and in such instances, the first smart or intelligent home controller 123 may be omitted). For instance, with reference to the discussion above, the first smart home device 124 may generate indications of whether one or more doors of the first residence 110 are opened; may generate one or more alarms (e.g., alarms which may be provided to the party 102 and/or to a police department for appropriate response); and/or may perform any other suitable functions involving or based upon the generation, collection, and/or analysis of intelligent home telematics data.

With continued reference to the actions described with respect to block 604, determining that an event has occurred or that a condition exists that is indicative that a risk of a loss associated with the party 102 is temporarily different from an ordinary risk of such loss may in some aspects be performed based upon data received by the one or more smart home devices from one or more additional smart home devices associated with one or more additional residences (e.g., the second smart home device 126 associated with the second residence 112) within a particular proximity of the first residence 110 (e.g., a proximity determined by the insurance provider and/or the first smart home device 124). In some aspects, determining that such an event has occurred or that such a condition exists may include determining that at least one property crime associated with at least one of the one or more additional residences has occurred. For instance, the second smart home device 126 may communicate a notification of a burglary at the second residence 112 to the first smart home device 124.

In another example, the second smart home device 126 may be notified by a further smart home device (not shown) associated with a further residence (not shown) within the particular proximity of the first residence 110 that a property crime(s) occurred, and the second smart home device 126 may transmit this notification to the first smart home device 124. The receipt of a notification(s) of a property crime(s) by the first smart home device 124 may cause the first smart home device 124 to determine that a risk of a loss associated with the party 102 (e.g., loss due to a property crime) is temporarily different from an ordinary risk of such loss.

In other aspects, determining that an event has occurred or that a condition exists that is indicative that a risk of a loss associated with the party 102 is temporarily different from an ordinary risk of such loss may include determining, using one or more smart home devices (e.g., the first smart home device 124) that extreme weather (e.g., extreme cold, heat, snow, rain, lightning, tornado, hurricane, etc.) is at, within a predetermined distance of, and/or forecasted to approach the first residence 110.

With reference to the discussion elsewhere herein, it should be appreciated that any suitable smart devices may communicate with one another (e.g., by generating, collecting, and/or transmitting vehicle telematics data or intelligent home telematics data) and/or with other devices, such as the insurance provider server 132, to determine actual risks of loss and/or actual need(s) for temporary insurance coverage based upon various events. The smart devices and/or other devices may communicate indications of such risks and/or such need for temporary insurance coverage to, for instance, other smart devices to prompt an offer of and/or purchase of (e.g., via such other smart devices, via the computing device 104, etc.) the temporary or “on demand” insurance coverage as described elsewhere herein. In various aspects, smart devices that may communicate indications of risks and/or a need for temporary insurance coverage may include, for instance, smart phones, smart thermostats, smart vehicles, security cameras, smart home appliances (e.g., oven, washer, etc.). It should be further appreciated from the teaching and disclosure herein that such smart devices may communicate indications of risks and/or a need for temporary insurance coverage within a same vehicle (e.g., the first vehicle 106), within a same residence (e.g., the first residence 110), and/or between vehicles, residences, etc.

The method 600 may include determining, at the one or more devices associated with the party 102, based upon a location of the party 102 and/or a speed of the party 102, that the party 102 is riding the bicycle 114 (block 606). The determination that the party 102 is riding the bicycle 114 in a manner similar to that described above, except that as described with respect to block 606, the determination is performed at the one or more devices associated with the party 102 instead of by the insurance provider server 132.

The method 600 may include determining, at the one or more devices associated with the party 102, habit data of the party 102 based upon previous activity data, where the previous activity data may be as described above and where the habit data may be indicative of at least one habit of the party 102 (e.g., following traffic rules or posted speed limits versus speeding), as described above (block 608). The method 600 may also include determining, at the one or more devices associated with the party 102, based upon the habit data, that the risk of the loss associated with the party 102 is temporarily higher (or lower, or otherwise different) than the ordinary risk of the loss (block 610). The determinations described with respect to blocks 608 and 610 involving habit data may be similar to the determinations involving habit data discussed above, except that the determinations described with respect to blocks 608 and 610 may be performed at the one or more devices associated with the party 102 instead of by the insurance provider server 132.

The method 600 may include determining, at the one or more devices associated with the party 102, that the party 102 is (i) traveling using a travel service, and/or (ii) expected to travel using the travel service within a predetermined amount of time (block 612). The determination described with respect to block 612 may be performed in a similar manner as that described with respect to block 312, except that as described with respect to block 612, the determination is performed at the one or more devices associated with the party 102 instead of by the insurance provider server 132. The determination that the party 102 is traveling using the travel service and/or is expected to travel using the travel service within a predetermined amount of time may cause the device(s) associated with the party 102 (such as the computing device 104 in this example) to determine that a risk of a loss associated with the party 102 is temporarily higher (or lower, or different, respectively) than an ordinary risk of such loss for reasons the same as or similar to those discussed above with respect to FIG. 3.

The method 600 may include determining, at the one or more devices associated with the party 102, that a location and/or an expected future location of the party (e.g., as indicated by the computing device 104 and/or other suitable device(s)) is/are associated with a risk of a loss associated with the party 102 that is temporarily higher (or lower, or different, respectively) than the ordinary risk of the loss (block 614). For instance, the determination described with respect to block 614 may be performed in a similar manner as that described with respect to block 314, except that as described with respect to block 614, the determination is performed at the one or more devices associated with the party 102 instead of by the insurance provider server 132.

The method 600 may include determining, at the one or more devices associated with the party 102, that the risk of the loss is temporarily higher (or lower, or different) than the ordinary risk by determining that the party 102 is currently engaged in, or is expected to engage in, a transaction with another party and that the other party has an associated risk of a fraudulent transaction that is higher (or lower, or different, respectively) than a predetermined risk (e.g., a risk set by the device(s) associated with the party 102 and/or by the insurance provider) (block 616). For example, the other party may be a merchant with respect to which a predetermined number or percentage of incidents of fraud have been reported to the insurance provider, and where data regarding such fraud has been communicated from the insurance provider server 132 to the device(s) associated with the party 102. In various aspects, the determination that the party 102 is currently engaged in or is expected to engage in such a transaction may be performed in a similar manner as that described with respect to block 318, except that as described with respect to block 616, the determination is performed at the one or more devices associated with the party 102 instead of by the insurance provider server 132.

It should be understood in light of the teaching and disclosure herein that one or more of the actions described with respect to blocks 602-616 may constitute all or part of the performance of the actions described with respect to block 502 of FIG. 5 to determine that a risk of a loss associated with the party 102 is temporarily higher (or lower, or different) than an ordinary risk of the loss. Moreover, it should be understood in light of the teaching and disclosure herein that one or more of the actions described with respect to blocks 602-616 need not be performed. For instance, in some aspects, once a risk of a loss associated with the party 102 is determined to be temporarily higher (or lower, or different) than the ordinary risk of the loss, the method 600 may proceed, as discussed below, to performance of the actions described with respect to block 504.

The method 600 may also include performance of the actions described with respect to block 504 in order to determine the one or more terms of the temporary insurance coverage as further discussed above with respect to, for example, block 206. The method 600 may further include performing the actions described with respect to blocks 506 and 508 to provide the indication of the availability of the temporary insurance coverage (block 506), and to send a request to the insurance provider server 132 for the temporary insurance coverage (block 508). Performing the actions described with respect to block 508 may in some aspects include performing one or more of the actions described with respect to block 404 to send an indication of a selection of an option to request the temporary insurance coverage, provide an indication that the risk of the loss associated with the party 102 is temporarily higher (or lower, or different) than ordinary, etc.

The method 600 may include additional, less, or alternate actions, including those discussed elsewhere herein, and/or may be implemented via an appropriate computing device(s) and/or processors thereof (e.g., the computing device 104, the first smart vehicle controller 120, the first smart or intelligent home controller 123, and/or the first smart home device 124), or via computer-executable instructions stored on non-transitory computer-readable medium or media.

Exemplary Providing of Insurance Coverage Associated with a Vehicle Using Temporary Risk Data

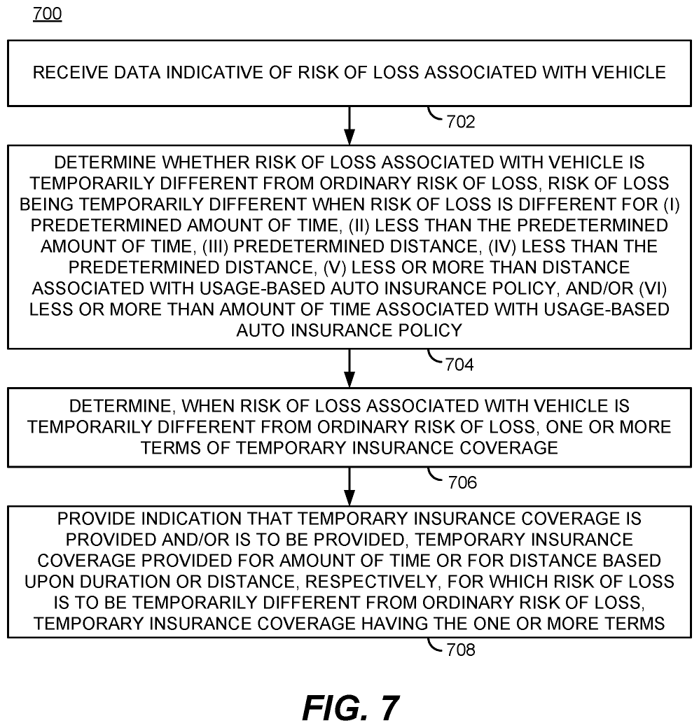

FIG. 7 illustrates an exemplary computer-implemented method 700 of providing insurance coverage associated with a vehicle (e.g., the first vehicle 106) using temporary risk data, in accordance with an exemplary aspect of the present disclosure. In one aspect, the method 700 may be implemented by one or more suitable devices of the temporary insurance coverage system 100, such as the computing device 104, the first smart vehicle controller 120, the second smart vehicle controller 122, and/or any suitable device(s) (including a device(s) that generate vehicle sensor data, smart vehicle controller data, autonomous vehicle data, vehicle telematics data, etc.). For instance, the method 700 may be performed by one or more processors, applications, and/or routines that are part of, stored by, and/or otherwise accessible to the computing device 104, the first smart vehicle controller 120, and/or the second smart vehicle controller 122. It will be appreciated from the teaching and disclosure herein that the method 700 may include a more particular implementation(s) of aspects of, for instance, the method 200.

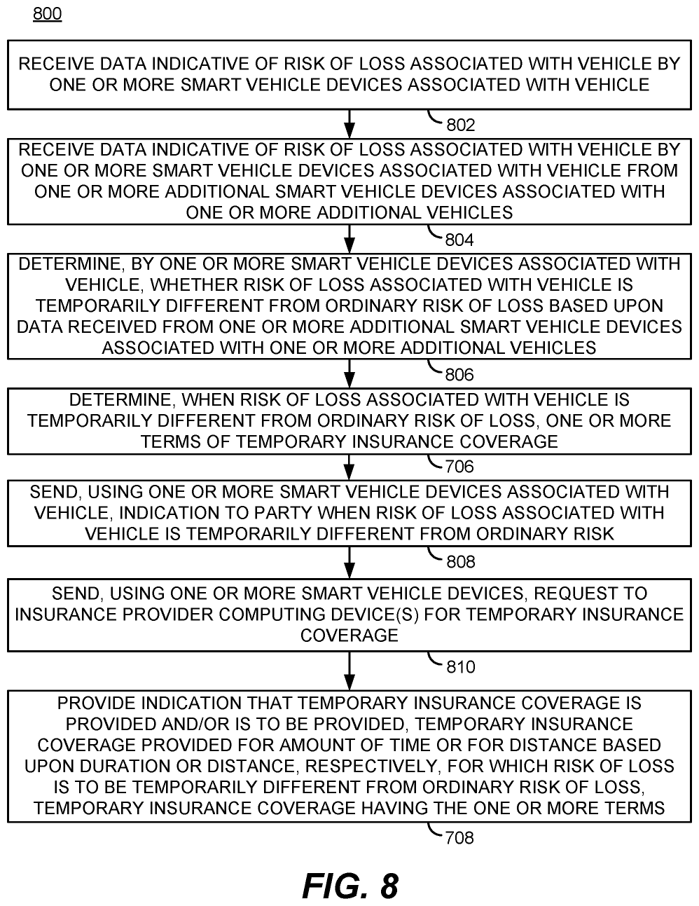

The method 700 may include receiving, by at least one of (i) one or more processors or (ii) one or more transceivers or sensors, data indicative of a risk of a loss associated with a vehicle (block 702). In some aspects, the one or more processors, transceivers, and/or sensors may be one or more processors, transceivers, and/or sensors of the insurance provider server 132. In other aspects, the one or more processors, transceivers, and/or sensors may be one or more processors, transceivers, and/or sensors of a device associated with the party 102, as described in further detail with respect to, for instance, FIG. 8. Additionally, in some aspects, the party may be the party 102 and the vehicle may be the first vehicle 106. The first vehicle 106 may be an autonomous vehicle, as further discussed herein.

The method 700 may include determining, by the one or more processors, based upon the data indicative of the risk of the loss associated with the first vehicle 106, whether the risk of the loss associated with the first vehicle 106 is temporarily different from an ordinary risk of the loss (block 704). The ordinary risk of the loss may be, for instance, a risk of the loss determined and/or expressed as described elsewhere herein. In some aspects, the risk of the loss associated with the first vehicle 106 may be determined to be temporarily different from the ordinary risk of the loss when the risk of the loss associated with the first vehicle 106 is different from the ordinary risk for (i) a predetermined amount of time (e.g., an amount of time determined by the insurance provider), (ii) less than the predetermined amount of time, (iii) a predetermined distance (e.g., a predetermined distance in miles), (iv) less than the predetermined distance (e.g., less than the predetermined distance in miles), (v) less or more than a distance (e.g., amount of miles) associated with a usage-based auto insurance policy that is issued to the party 102 and covers the first vehicle 106, and/or (vi) less or more than an amount of time associated with a usage-based auto insurance policy that is issued to the party 102 and covers the first vehicle 106.

With continued reference to the actions described with respect to block 704, in aspects where a usage-based auto insurance policy is issued to the party 102, the usage-based auto insurance policy may be, for instance, a pay-by-mile auto insurance policy. The pay-by-mile auto insurance policy may allow the party 102 to obtain and pay for auto insurance (e.g., including collision coverage, liability coverage, and/or any other suitable coverage(s)) that covers the first vehicle 106 for a particular amount or number of miles associated with the pay-by-mile auto insurance policy. In various aspects, the amount of miles associated with the pay-by-mile auto insurance policy may be an amount of miles predetermined by the party 102 and/or an amount of miles that the party 102 anticipates driving within a period of time for which the pay-by-mile auto insurance policy is effective. It will be appreciated from the teaching and disclosure herein that the discussion of miles is by way of example only, that any other suitable unit of distance may be used for providing usage-based insurance, and that any other suitable distance may thus be associated with usage-based insurance.

In other aspects where the usage-based auto insurance policy is issued to the party 102, the usage-based auto insurance policy may be, for instance, a pay-by-time auto insurance policy. The pay-by-time auto insurance policy may allow the party 102 to obtain and pay for auto insurance that covers the first vehicle 106 for a particular amount of time associated with the pay-by-time auto insurance policy. In various aspects, the amount of time associated with the pay-by-time auto insurance policy may be an amount of time predetermined by the party 102 and/or an amount of time that the party 102 expects to be driving and/or otherwise using (e.g., renting) the first vehicle 106.

Additionally or alternatively, in some aspects, the data indicative of the risk of the loss associated with the first vehicle 106 may indicate that the risk of the loss is temporarily different from the ordinary risk of the loss when the data indicative of the risk of the loss includes data indicating abnormal vehicle congestion within a predetermined area of the first vehicle 106; data indicating abnormal traffic within a predetermined area of the first vehicle 106; data indicating abnormal weather conditions within a predetermined area of the first vehicle 106; data indicating abnormal driving conditions within a predetermined area of the first vehicle 106 (e.g., a road closure, even if abnormal traffic is not present at or near the site of the road closure); data indicating an abnormal number (e.g., higher than a predetermined threshold) of accidents and/or vehicle collisions within a predetermined area of the first vehicle 106; data indicating road construction within a predetermined area of the first vehicle 106; and/or any other suitable data indicative of an increased or decreased risk of a loss (e.g., collision) associated with the first vehicle 106 and/or the party 102. Such data may, for instance, constitute data indicating that the risk of the loss associated with the first vehicle 106 is different from the ordinary risk for a predetermined amount of time or a predetermined distance (or less than the predetermined amount of time or less than the predetermined distance), and/or for less or more than a distance or amount of time associated with a usage-based auto insurance policy as described above.

The method 700 may include determining, by the one or more processors when the risk of the loss associated with the first vehicle 106 is temporarily different from the ordinary risk of the loss, one or more terms of temporary insurance coverage for the loss having the risk that is temporarily different from the ordinary risk of the loss (block 706). In various aspects, the one or more terms of the temporary insurance coverage for the loss may be determined based upon an amount by which the risk of the loss is temporarily different from the ordinary risk of the loss (e.g., as determined based upon the data indicative of the risk of the loss); a duration for which the risk of the loss is to be temporarily different from the ordinary risk of the loss (e.g., as determined based upon the data indicative of the risk of the loss); or a distance (e.g., in miles, such as when the temporary insurance coverage is to be usage-based auto insurance) for which the risk of the loss is to be temporarily different from the ordinary risk; and/or any other suitable factors.

In various aspects, the duration for which the risk of the loss is to be temporarily different from the ordinary risk of the loss and/or the distance for which the risk of the loss is to be temporarily different from the ordinary risk may be determined based upon a vehicle route of the first vehicle 106 that is input into a vehicle navigation unit of the first vehicle 106 and/or selected via the vehicle navigation unit. Additionally or alternatively, in various aspects, the one or more terms of the temporary insurance coverage may include a deductible; a premium; a rating of the party 102 upon which the temporary insurance coverage is based; a duration of the temporary insurance coverage; an out-of-pocket maximum liability of the party 102 for the loss insured by the temporary insurance coverage; an indication of a modification(s) to a usage-based auto insurance policy or other additional insurance coverage maintained by the party 102 (such other coverage being discussed elsewhere herein); and/or other terms such as those described elsewhere herein.

In some aspects where a usage-based auto insurance policy is issued to the party 102 as a pay-by-mile (or other pay-by-distance) auto insurance policy, the temporary insurance coverage may be provided for (i) the predetermined distance (e.g., amount of miles) discussed with respect to block 704, (ii) less than the predetermined distance (e.g., amount of miles) discussed with respect to block 704, and/or (iii) less or more than the amount of miles (or other distance) associated with the pay-by-mile (or other pay-by-distance) auto insurance policy. As such, it will be appreciated in light of the teaching and disclosure herein that the party 102 may have a pay-by-mile (or other pay-by-distance) auto insurance policy, and may obtain temporary insurance coverage as described herein where the temporary insurance coverage is also a pay-by-mile (or other usage-based) auto insurance policy. For instance, the temporary insurance coverage may be pay-by-mile auto insurance coverage that modifies one or more terms of the pay-by-mile auto insurance policy already issued to the party 102, and may be for a shorter time than the pay-by-mile auto insurance policy already issued to the party 102 (e.g., to account for the risk of the loss being temporarily different from the ordinary risk of the loss).

In certain aspects where a usage-based auto insurance policy is issued to the party 102 as a pay-by-time auto insurance policy, the temporary insurance coverage may be provided for (i) the predetermined amount of time discussed with respect to block 704, (ii) less than the predetermined amount of time discussed with respect to block 704, and/or (iii) less or more than the amount of time associated with the pay-by-time auto insurance policy. As such, it will be appreciated in light of the teaching and disclosure herein that the party 102 may have a pay-by-time auto insurance policy, and may obtain temporary insurance coverage as described herein where the temporary insurance coverage is also a pay-by-time (or other usage-based) auto insurance policy. For instance, the temporary insurance coverage may be pay-by-time auto insurance coverage that modifies one or more terms of the pay-by-time auto insurance policy already issued to the party 102, and may be for a shorter time than the pay-by-time auto insurance policy already issued to the party 102 (e.g., to account for the risk of the loss being temporarily different from the ordinary risk of the loss).

The method 700 may include providing, by the one or more processors, transceivers, and/or sensors, an indication that the temporary insurance coverage is provided and/or is to be provided (block 708). In some aspects, the temporary insurance coverage may be provided for an amount of time or for a distance based upon the duration or the distance, respectively, for which the risk of the loss is to be temporarily different from the ordinary risk of the loss. The temporary insurance coverage may be provided to the party 102 to cover the first vehicle 106 for the loss, and may have the one or more terms determined as described with respect to block 706.

The method 700 may include additional, less, or alternate actions, including those discussed elsewhere herein, and/or may be implemented via an appropriate computing device(s) and/or processors thereof, or via computer-executable instructions stored on non-transitory computer-readable medium or media.

FIG. 8 illustrates another exemplary computer-implemented method 800 of providing insurance coverage associated with a vehicle (e.g., the first vehicle 106) using temporary risk data, in accordance with an exemplary aspect of the present disclosure. In one aspect, the method 800 may be implemented by one or more suitable devices of the temporary insurance coverage system 100, such as the computing device 104, the first smart vehicle controller 120, the second smart vehicle controller 122, and/or any suitable device(s) (including a device(s) that generate vehicle sensor data, smart vehicle controller data, autonomous vehicle data, vehicle telematics data, etc.). For instance, the method 800 may be performed by one or more processors, applications, and/or routines that are part of, stored by, and/or otherwise accessible to the computing device 104, the first smart vehicle controller 120, and/or the second smart vehicle controller 122. The method 800 may include a more particular implementation(s) of aspects of, for instance, the method 700.

The method 800 may include receiving the data indicative of the risk of the loss as described with respect to the method 700 by at least one of (i) one or more processors of one or more smart vehicle devices (e.g., the first smart vehicle controller 120) associated with a vehicle (e.g., the first vehicle 106) or (ii) one or more transceivers or sensors of the one or more smart vehicle devices associated with the first vehicle 106 (block 802).

In some aspects, the method 800 may more particularly include the at least one of (i) the one or more processors of the one or more smart vehicle devices associated with the first vehicle 106 or (ii) the one or more transceivers or sensors of the one or more smart vehicle devices associated with the first vehicle 106 receiving the data indicative of the risk of the loss as described with respect to the method 700 from one or more additional smart vehicle devices associated with one or more additional vehicles (e.g., the second smart vehicle controller 122 associated with the second vehicle 108) (block 804).

The method 800 may include determining, by one or more processors of the one or more smart vehicle devices associated with the first vehicle 106, whether the risk of the loss associated with the first vehicle 106 is temporarily different from the ordinary risk based upon data received from one or more additional smart vehicle devices associated with one or more additional vehicles (e.g., based upon data received from the second smart vehicle controller 122) (block 806). The determination described with respect to block 806 may be made based upon the data received from the one or more additional smart vehicle devices in the manner described with respect to, for example, block 704. In other aspects, determining whether the risk of the loss associated with the first vehicle 106 is temporarily different from the ordinary risk may be performed based upon data received from the one or more smart vehicle devices associated with the first vehicle 106, in addition to or instead of being performed based upon data received from the one or more additional smart vehicle devices associated with the one or more additional vehicles.

The method 800 may include performing the actions described with respect to block 706 to determine, by the one or more processors when the risk of the loss associated with the first vehicle 106 is temporarily different from the ordinary risk of the loss, one or more terms of temporary insurance coverage for the loss having the risk that is temporarily different from the ordinary risk of the loss, as further described above.

The method 800 may also include sending, using the one or more smart vehicle devices (e.g., the first smart vehicle controller 120) associated with the first vehicle 106, such as via one or more user interfaces, an indication to the party 102 (who may be a driver or passenger of the first vehicle 106) when the risk of the loss associated with the first vehicle 106 is temporarily different from the ordinary risk (block 808). In various aspects, the indication to the party 102 may include an indication of an availability of the temporary insurance coverage for purchase by the party 102 (such as via the computing device 104), a recommendation of the temporary insurance coverage to the party 102, and/or a price (e.g., premium) associated with the temporary insurance coverage.

The method 800 may include sending, using the one or more smart vehicle devices (e.g., the first smart vehicle controller 120) associated with the first vehicle 106, a request to one or more insurance provider computing devices (e.g., the insurance provider server 132) for the temporary insurance coverage (block 810). In some aspects, the request for the temporary insurance coverage may be a request for temporary insurance coverage for a requested amount of time or a request for temporary insurance coverage for a requested distance (e.g., when requesting usage-based temporary insurance coverage). The requested amount of time or the requested distance may be based upon a determined duration or a determined distance, respectively, for which the risk of the loss associated with the first vehicle 106 is to be temporarily different. For instance, the party 102 may request the temporary insurance coverage for a duration or distance that is equal to the determined duration or the determined distance for which the risk of the loss is to be temporarily different. In another example, the party 102 may request the temporary insurance coverage for a duration or a distance that is greater than the determined duration or the determined distance by a desired amount so that the party 102 is more assured of obtaining the temporary insurance coverage for a needed duration or distance. The party 102 may request the temporary insurance coverage as described herein so as to obtain the temporary insurance coverage for the requested amount of time or the requested distance.

The method 800 may include performing the actions described with respect to block 708 to provide the indication that the temporary insurance coverage is provided and/or is to be provided to cover the first vehicle 106 for the loss as described above. For example, the method 800 may include performing the actions described with respect to block 708 when the party 102 sends the request for the temporary insurance coverage as described above with respect to block 810.

The method 800 may include additional, less, or alternate actions, including those discussed elsewhere herein, and/or may be implemented via an appropriate computing device(s) and/or processors thereof, or via computer-executable instructions stored on non-transitory computer-readable medium or media.

Exemplary Providing of Insurance Coverage Associated with a Residence Using Temporary Risk Data

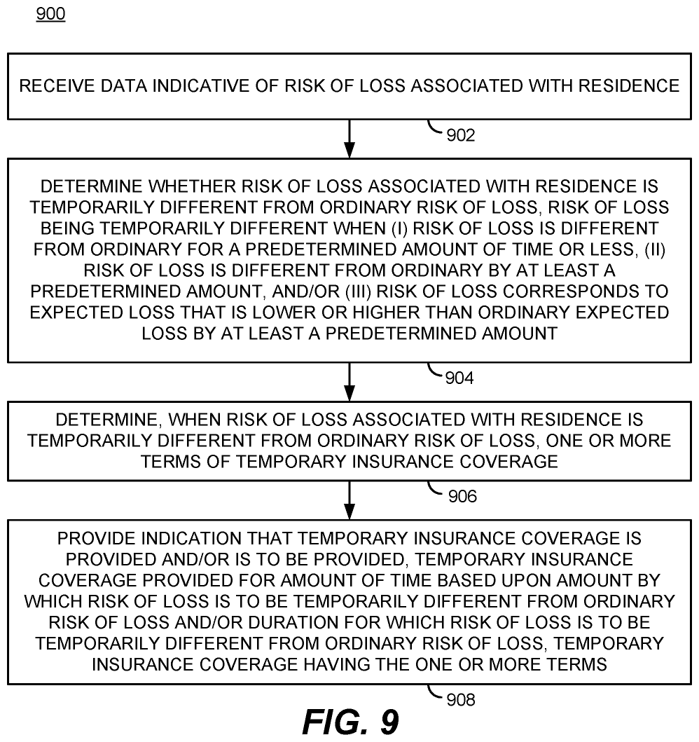

FIG. 9 illustrates an exemplary computer-implemented method 900 of providing insurance coverage associated with a residence (e.g., the first residence 110) using temporary risk data, in accordance with an exemplary aspect of the present disclosure. In one aspect, the method 900 may be implemented by one or more suitable devices of the temporary insurance coverage system 100, such as the computing device 104, the first smart or intelligent home controller 123, the first smart home device 124, the second smart or intelligent home controller 125, the second smart home device 126, and/or any suitable device(s) (including a device(s) that generate smart or intelligent home telematics data). For instance, the method 900 may be performed by one or more processors, applications, and/or routines that are part of, stored by, and/or otherwise accessible to the computing device 104, the first smart or intelligent home controller 123, the first smart home device 124, the second smart or intelligent home controller 125, the second smart home device 126. It will be appreciated from the teaching and disclosure herein that the method 900 may include a more particular implementation(s) of aspects of, for instance, the method 200.

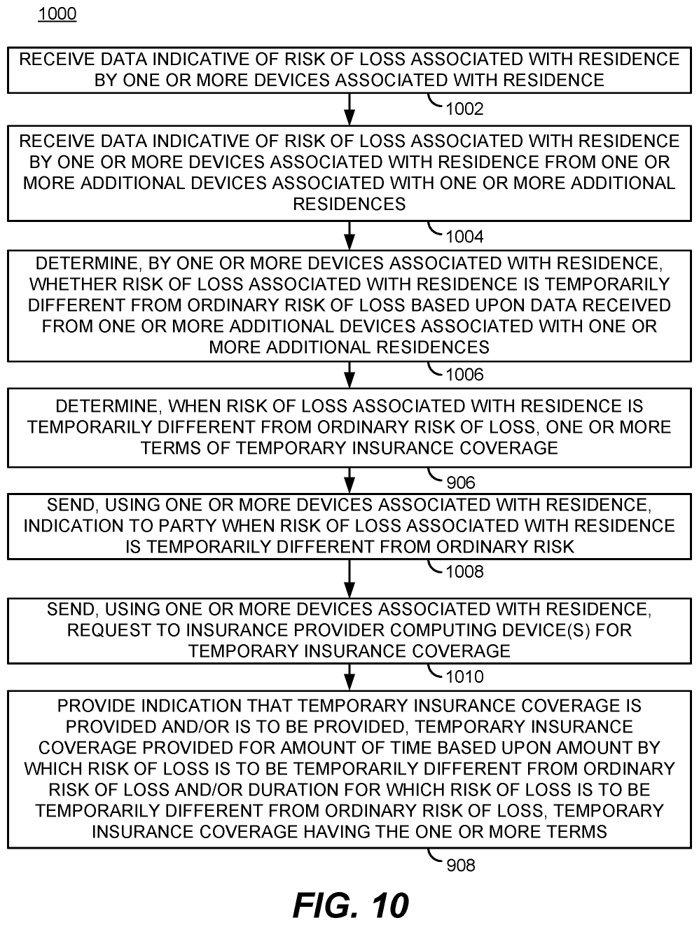

The method 900 may include receiving, by at least one of (i) one or more processors or (ii) one or more transceivers or sensors, data indicative of a risk of a loss associated with a residence (block 902). In some aspects, the one or more processors, transceivers, and/or sensors may be one or more processors, transceivers, and/or sensors of the insurance provider server 132. In other aspects, the one or more processors, transceivers, and/or sensors may be one or more processors, transceivers, and/or sensors of a device associated with the party 102, as described in further detail with respect to, for instance, FIG. 10. Additionally, in some aspects, the party may be the party 102 and the residence may be the first residence 110.

The method 900 may include determining, by the one or more processors, based upon the data indicative of the risk of the loss associated with the first residence 110, whether the risk of the loss associated with the first residence 110 is temporarily different from an ordinary risk of the loss (block 904). The ordinary risk of the loss may be, for instance, a risk of the loss determined and/or expressed as described elsewhere herein. In some aspects, the risk of the loss associated with the first residence 110 may be determined to be temporarily different from the ordinary risk of the loss when (i) the risk of the loss associated with the first residence 110 is different from the ordinary risk for a predetermined amount of time or less (e.g., the predetermined amount of time being determined by the insurance provider), (ii) the risk of the loss is different from the ordinary risk by at least a predetermined amount (e.g., a predetermined increase or decrease in percentage risk), and/or (iii) the risk of the loss corresponds to an expected loss that is lower or higher than an ordinary expected loss by at least a predetermined amount. An expected loss may be determined as a statistically expected loss, such as by determining a statistically expected value (e.g., in dollars) of the loss. The expected loss may thus be lower or higher than an ordinary (e.g., average) expected loss by at least a predetermined amount (e.g., an amount in dollars determined by the insurance provider).

In some aspects, the expected loss may be lower or higher than the ordinary expected loss by at least the predetermined amount when an expected cost (e.g., a statistically expected cost) of repair and/or replacement of at least a portion of the first residence 110 as a result of the loss is lower or higher, by at least the predetermined amount, than an ordinary (e.g., average) expected cost (e.g., a statistically expected cost) of repair and/or replacement of at least a portion of the first residence 110 as a result of the loss.

Additionally or alternatively, in some aspects, the data indicative of the risk of the loss associated with the first residence 110 may indicate that the risk of the loss is temporarily different from the ordinary risk of the loss when the data indicative of the risk of the loss includes data indicating abnormal neighborhood conditions (e.g., a parade in or within a particular distance of a neighborhood of the first residence 110, etc.); abnormal conditions interior to the first residence 110 (e.g., a large number of occupants, such as during a social event, etc.); abnormal conditions exterior to the first residence 110 (e.g., construction on a street on which the first residence 110 is located, etc.); abnormal appliance operation associated with the first residence 110 (e.g., a malfunctioning sump pump, etc.); abnormal weather associated with the first residence 110 (e.g., a blizzard, heavy rain, etc. at or within a particular distance of the first residence 110); abnormal crime associated with the first residence 110 (e.g., any crime within a predetermined area of the first residence 110, a number of crimes such as property crimes within a predetermined area of the first residence 110 that exceeds a predetermined number within a predetermined amount of time, etc.); and/or other abnormal activity associated with the first residence 110 (e.g., a helicopter lift being performed near the first residence 110, etc.). With reference to the discussion above, such data may, for instance, constitute data indicating (i) that the risk of the loss associated with the first residence 110 is different from the ordinary risk for a predetermined amount of time or less, (ii) that the risk of the loss is different from the ordinary risk by at least a predetermined amount, and/or (iii) that the risk of the loss corresponds to an expected loss that is lower or higher than an ordinary expected loss by at least a predetermined amount.

The method 900 may include determining, by the one or more processors when the risk of the loss associated with the first residence 110 is temporarily different from the ordinary risk of the loss, one or more terms of temporary insurance coverage for the loss having the risk that is temporarily different from the ordinary risk of the loss (block 906). In various aspects, the one or more terms of the temporary insurance coverage for the loss may be determined based upon an amount by which the risk of the loss is temporarily different from the ordinary risk of the loss (e.g., as determined based upon the data indicative of the risk of the loss); a duration for which the risk of the loss is to be temporarily different from the ordinary risk of the loss (e.g., as determined based upon the data indicative of the risk of the loss); and/or any other suitable factors.

In various aspects, the one or more terms of the temporary insurance coverage may include a deductible; a premium; a rating of the party 102 upon which the temporary insurance coverage is based; a duration of the temporary insurance coverage; an out-of-pocket maximum liability of the party 102 for the loss insured by the temporary insurance coverage; an indication of a modification(s) to additional (e.g., longer-duration) insurance coverage maintained by the party 102 (such longer-duration coverage being discussed elsewhere herein); and/or other terms such as those described elsewhere herein. In various aspects, the modification(s) to the longer-duration insurance coverage may include a modification of a cost (e.g., premium) associated with the longer-duration insurance coverage; a modification of an amount of the loss covered by the longer-duration insurance coverage; an amount of time for which such modification(s) is/are effective; and/or any other suitable modification(s).

The method 900 may include providing, by the one or more processors, transceivers, and/or sensors, an indication that the temporary insurance coverage is provided and/or is to be provided (block 908). In some aspects, the temporary insurance coverage may be provided for an amount of time based upon the amount by which the risk of the loss is to be temporarily different from the ordinary risk and/or the duration for which the risk of the loss is to be temporarily different from the ordinary risk. The temporary insurance coverage may be provided to the party 102 to cover the first residence 110 for the loss, and may have the one or more terms determined as described with respect to block 906.

The method 900 may include additional, less, or alternate actions, including those discussed elsewhere herein, and/or may be implemented via an appropriate computing device(s) and/or processors thereof, or via computer-executable instructions stored on non-transitory computer-readable medium or media.

FIG. 10 illustrates another exemplary computer-implemented method 1000 of providing insurance coverage associated with a residence (e.g., the first residence 110) using temporary risk data, in accordance with an exemplary aspect of the present disclosure. In one aspect, the method 1000 may be implemented by one or more suitable devices of the temporary insurance coverage system 100, such as the computing device 104, the first smart or intelligent home controller 123, the first smart home device 124, the second smart or intelligent home controller 125, the second smart home device 126, and/or any suitable device(s) (including a device(s) that generate smart or intelligent home telematics data). For instance, the method 1000 may be performed by one or more processors, applications, and/or routines that are part of, stored by, and/or otherwise accessible to the computing device 104, the first smart or intelligent home controller 123, the first smart home device 124, the second smart or intelligent home controller 125, and/or the second smart home device 126. The method 1000 may include a more particular implementation(s) of aspects of, for instance, the method 900.

The method 1000 may include receiving the data indicative of the risk of the loss as described with respect to the method 900 by at least one of (i) one or more processors of one or more devices (e.g., the first smart home device 124) associated with a residence (e.g., the first residence 110) or (ii) one or more transceivers or sensors of the one or more devices associated with the first residence 110 (block 1002). With reference to the discussion elsewhere herein, in some aspects, the one or more devices associated with the first residence 110 may include one or more smart home devices (e.g., the first smart home device 124, and/or the first smart or intelligent home controller 123, etc.) and/or a home security system that indicates abnormal crime associated with the first residence 110. Additionally or alternatively, in some aspects, the one or more devices associated with the first residence 110 may include a mobile phone, a smart thermostat, a security camera, a smart sump pump, a smart light, a smart light bulb, a smart stove, a smart oven, a smart dishwasher, a smart refrigerator, a smart freezer, a smart washer, a smart dryer, and/or any other suitable device(s).

With further reference to the discussion elsewhere herein, in some aspects, the method 1000 may more particularly include the at least one of (i) the one or more processors of the one or more devices associated with the first residence 110 or (ii) the one or more transceivers or sensors of the one or more devices associated with the first residence 110 receiving the data indicative of the risk of the loss as described with respect to the method 900 from one or more additional devices associated with one or more additional residences (e.g., the second smart home device 126 associated with the second residence 112) (block 1004). In some aspects, the one or more additional devices associated with the one or more additional residences may include one or more home security systems associated with the one or more additional residences (e.g., a home security system of the second residence 112). The one or more home security systems may indicate abnormal crime associated with the first residence 110 based upon crime within, for each one of the one or more home security systems associated with the one or more additional residences, a predetermined area of a respective one of the one or more additional residences. Thus, any one or more of the one or more home security systems associated with the one or more additional residences may, for instance, detect a burglary or other property crime at a corresponding additional residence, and communicate an indication of the burglary or other property crime to other home security systems of the one or more additional residences. An indication of the burglary or other property crime, and any indication(s) of other detected crimes such as other detected property crimes associated with the one or more additional residences, may be communicated to the first residence 110 (e.g., to a home security system thereof) to indicate that abnormal crime is associated with the first residence 110 based upon the crime(s) occurring at the one or more additional residences. Such communications may occur via, for example, the network 130, any suitable network, and/or any other suitable communicative connections between residences.

The method 1000 may include determining, by one or more processors of the one or more devices associated with the first residence 110, whether the risk of the loss associated with the first residence 110 is temporarily different from the ordinary risk based upon data received from one or more additional devices associated with one or more additional residences (e.g., based upon data received from the second smart home device 126) (block 1006). The determination described with respect to block 1006 may be made based upon the data received from the one or more additional devices associated with the one or more additional residences in the manner described with respect to, for example, block 904. In other aspects, determining whether the risk of the loss associated with the first residence 110 is temporarily different from the ordinary risk may be performed based upon data received from the one or more devices associated with the first residence 110, in addition to or instead of being performed based upon data received from the one or more additional devices associated with the one or more additional residences.

The method 1000 may include performing the actions described with respect to block 906 to determine, by the one or more processors when the risk of the loss associated with the first residence 110 is temporarily different from the ordinary risk of the loss, one or more terms of temporary insurance coverage for the loss having the risk that is temporarily different from the ordinary risk of the loss, as further described above.

The method 1000 may also include sending, using the one or more devices (e.g., the first smart home device 124) associated with the first residence 110, such as via one or more user interfaces, an indication to the party 102 (who may be a resident and/or owner of the first residence 110) when the risk of the loss associated with the first residence 110 is temporarily different from the ordinary risk (block 1008). In various aspects, the indication to the party 102 may include an indication of an availability of the temporary insurance coverage for purchase by the party 102 (such as via the computing device 104), a recommendation of the temporary insurance coverage to the party 102, and/or a price (e.g., premium) associated with the temporary insurance coverage.

The method 1000 may include sending, using the one or more devices (e.g., the first smart home device 124) associated with the first residence 110, a request to one or more insurance provider computing devices (e.g., the insurance provider server 132) for the temporary insurance coverage (block 1010). In some aspects, the request for the temporary insurance coverage may be a request for temporary insurance coverage for a requested duration or a request for temporary insurance coverage for a requested amount (e.g., amount of loss). The requested duration or the requested amount may be based upon a determined duration or a determined amount, respectively, for which or by which, respectively, the risk of the loss associated with the first residence 110 is to be temporarily different. The determined amount by which the risk of the loss associated with the first residence 110 is to be temporarily different may be, for instance, an amount by which the expected loss as described above is to be lower or higher than an ordinary expected loss. In one example, the party 102 may request the temporary insurance coverage for a duration or an amount that is equal to the determined duration or the determined amount. In another example, the party 102 may request the temporary insurance coverage for a duration or an amount that is greater than the determined duration or the determined amount so that the party 102 is more assured of obtaining the temporary insurance coverage for a needed duration or amount. The party 102 may request the temporary insurance coverage as described herein so as to obtain the temporary insurance coverage for the requested duration or the requested amount.

The method 1000 may include performing the actions described with respect to block 908 to provide the indication that the temporary insurance coverage is provided and/or is to be provided to cover the first residence 110 for the loss as described above. For example, the method 1000 may include performing the actions described with respect to block 908 when the party 102 sends the request for the temporary insurance coverage as described above with respect to block 1010.

The method 1000 may include additional, less, or alternate actions, including those discussed elsewhere herein, and/or may be implemented via an appropriate computing device(s) and/or processors thereof, or via computer-executable instructions stored on non-transitory computer-readable medium or media.

### Additional Exemplary Functionality and Use Cases

As discussed elsewhere herein, aspects include, inter alia, determining that a risk of a loss associated with a party (e.g., the party 102) is temporarily different from an ordinary risk of the loss associated with the party 102; determining one or more terms of temporary insurance coverage for the loss having the risk that is temporarily different from ordinary; and providing such temporary insurance coverage to the party 102. The systems and methods described herein thus facilitate automated offering of temporary insurance in an “on-demand” fashion based upon actual need as determined by, for instance, the insurance provider server 132, the smart vehicle controllers 120 and 122, and/or the smart home controllers and/or devices 123-126.

In some aspects, the providing and/or offering of temporary insurance coverage may be triggered by a particular (e.g., predetermined at the insurance provider server 132) percentage different risk of the loss associated with the party 102. The temporary insurance coverage may priced lower (or higher, depending upon the nature of the temporary level of risk) than conventional (e.g., annual-basis) insurance coverage to account for the temporary, on-demand nature of the temporary insurance coverage. In other aspects, the party 102 may predetermine (e.g., using the computing device 104) a percentage or amount of change in the risk of the loss associated with the party 102, and when the risk of the loss associated with the party 102 has changed by the predetermined percentage or amount, the computing device 104 may automatically purchase temporary insurance coverage as described elsewhere herein via, for instance, a communicative connection with the insurance provider server 132. In any event, it will be understood in light of the teaching and disclosure herein that the temporary insurance coverage may cover a narrower range of losses (or only one particular type of loss), and may in general be more narrowly tailored (e.g., may be named perils insurance coverage) than conventional insurance.

The one or more ratings stored at the service provider server 140 and/or at the rating server 142 may, in various aspects, be gathered by one or more organizations such as Yelp Inc. of San Francisco, Calif.; Consumer Reports; Better Business Bureau®; AARP, Inc. of Washington, D.C.; crime reporting organizations; and/or any other suitable organizations. Such one or more organizations may own and/or operate the rating server 142, in some aspects, and may make the one or more ratings stored at the rating server 142 available to the insurance provider server 132.

In some aspects, the party 102 may indicate to the insurance provider server 132 (or to and/or via another suitable device(s), such as the computing device 104) that the party 102 is traveling on vacation, and may further indicate the mode of travel, such as by automobile (e.g., in the first vehicle 106). In response, temporary insurance coverage may be offered and/or provided to the party 102 to cover differing risks of loss associated with the travel and/or the mode of travel (e.g., to cover a temporarily different risk of loss due to luggage racks and/or valuables in the first vehicle 106, to cover a temporarily different risk of loss due to the party 102 driving a trailer for the vacation (where the first vehicle 106 may be a trailer), etc.). In some aspects, temporary insurance coverage may also cover differing risks of loss based upon activities undertaken during travel. For instance, temporary insurance coverage may be offered and/or provided when the party 102 books an off-road activity such as a hot air balloon trip, etc. and makes data regarding such booking available to the insurance provider server 132, such as with the permission or affirmative consent of the party 102 to facilitate the providing of temporary insurance coverage. In some aspects, the insurance provider server 132 may be notified that the party 102 is traveling or will travel at a particular time based upon emails made available to the insurance provider server 132; credit card data (e.g., purchase information such as flight purchase information, hotel reservation information, etc.) made available to the insurance provider server 132; etc., with such information being made available to the insurance provider server 132 (or other suitable device(s)) with the permission or affirmative consent of the party 102 to facilitate the providing of temporary insurance coverage.

More generally, temporary insurance coverage may also be provided depending upon a mode of transportation being used, whether or not during a vacation. For instance, temporary insurance coverage may be provided based upon a rating of a driver of an on-demand driving service or a rating of a driver of a taxi service; based upon the party 102 renting a bicycle, motorcycle, etc.; and/or based upon the party 102 utilizing any other suitable mode of transportation and based upon attributes of such a mode of transportation, such as a driver rating.

### Exemplary Computing Device

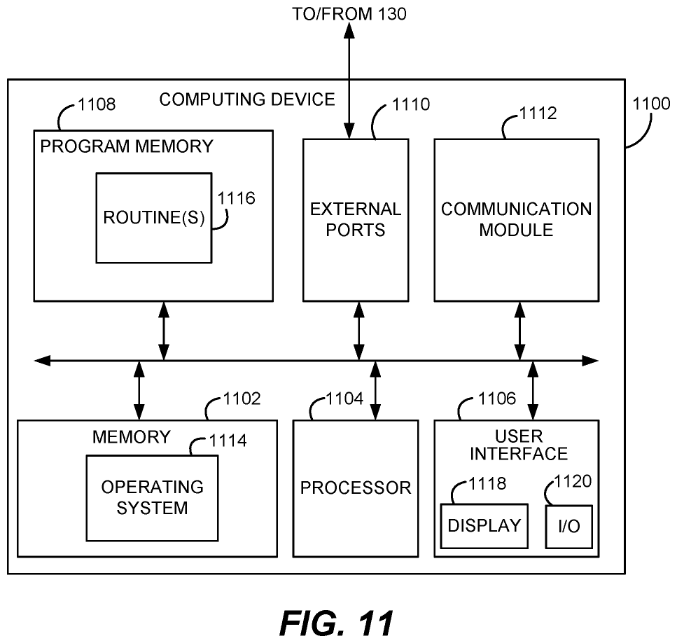

FIG. 11 illustrates a diagram of an exemplary computing device 1100 that may implement one or more of the functionalities discussed herein, in accordance with an exemplary aspect of the present disclosure. The computing device 1100 may be an implementation of any suitable computing device discussed herein, such as, for instance, an implementation of the insurance provider server 132 and/or the computing device 104. While the computing device 1100 is illustrated as including certain components and functionality, it should be appreciated that additional, alternate, or fewer components and/or functionality may be included in the computing device 1100 (e.g., in any one or more of the computing devices discussed elsewhere herein).

The computing device 1100 may include a memory 1102, a processor 1104, a user interface 1106, a program memory 1108, external ports 1110, and a communication module 1112. In an aspect, the memory 1102 may store an operating system 1114 configured to facilitate the functionality of the computing device 1100 as described herein.

The program memory 1108 may store one or more routines or applications (e.g., machine readable instructions) 1116. For instance, when the computing device 1100 is an implementation of the computing device 104, the routine(s) 1116 may include an app configured to provide functionality from the insurance provider to the party 102 as discussed herein. It should be appreciated that other routine(s) and/or application(s) are envisioned, including when the computing device 1100 is an implementation of a computing device other than the computing device 104.

The processor 1104 may interface with the memory 1102 to execute the operating system 1114 and the routine(s) 1116. The memory 1102 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and/or other suitable form(s) of memory.

The communication module 1112 may be configured to communicate data, such as data generated by execution of one or more of the routine(s) 1116, via one or more networks such as the network 130. In one aspect, the communication module 1112 may include one or more transceivers (e.g., WWAN, WLAN, WPAN transceivers, and/or any other suitable type(s) of transceiver(s)) functioning in accordance with IEEE standards, 3GPP standards, or other standards, and configured to receive and transmit data via the external ports 1110. Thus, the one or more transceivers may be regarded as associated with the processor 1102 and/or as associated with the computing device 1100. In one aspect, only a single external port 1110 may be implemented in the computing device 1100.

The user interface 1106 may be configured to present information to a user and/or receive inputs from the user. As illustrated in FIG. 11, the user interface 1106 may include a display 1118 and I/O components 1120 (e.g., ports, capacitive or resistive touch sensitive input panels, keys, buttons, lights, LEDs, speakers, microphones, etc.). The user may access the computing device 1100 via the user interface 1106 to view and/or use data generated during execution of one or more of the routine(s) 1116, and/or to perform any other suitable function(s). In one aspect, the computing device 1100 may perform the functionalities as discussed herein as part of a “cloud” network and/or may otherwise communicate with other hardware or software components within the cloud to send, retrieve, and/or otherwise analyze data. In some embodiments, any of the financial or other transactions described herein, such as the transactions discussed herein related to providing consumers with, or the purchase of, “on-demand” or temporary insurance, may be documented or conducted in a blockchain or blockchain-type of computing environment. It should be appreciated that in view of the various components thereof, the computing device 1100 may also be referred to as a “computer system” or a “computing system.”

In general, a computer program product in accordance with an aspect may include a non-transitory computer-readable storage medium (e.g., standard random access memory (RAM), an optical disc, a universal serial bus (USB) drive, or the like) having computer-readable program code embodied therein, wherein the computer-readable program code is configured/adapted to be executed by the processor 1104 (e.g., working in connection with the operating system 1114) to facilitate the functions as described herein. In this regard, the program code may be implemented in any desired language, and may be implemented as machine code, assembly code, byte code, interpretable source code or the like (e.g., via Python, or other languages, such as C, C++, Java, Actionscript, Objective-C, Javascript, CSS, XML, etc.). In some aspects, the computer program product may be part of a cloud network of resources.

### Exemplary Method of Providing Insurance Coverage Using Temporary Risk Data

As depicted by, and discussed in relation to, FIGS. 1-8 and 11, for example, in one aspect, a computer-implemented method of providing insurance coverage using temporary risk data may be provided. The method may include: (1) receiving, by at least one of (i) one or more processors or (ii) one or more transceivers or sensors, data indicative of a risk of a loss associated with a vehicle (e.g., an autonomous vehicle); (2) determining, by the one or more processors, based upon the data indicative of the risk of the loss associated with the vehicle, whether the risk of the loss associated with the vehicle is temporarily different from an ordinary risk of the loss, the risk of the loss being temporarily different from the ordinary risk of the loss when the risk of the loss is lower or higher than the ordinary risk of the loss for at least one of (i) a predetermined amount of time, (ii) less than the predetermined amount of time, (iii) a predetermined distance, (iv) less than the predetermined distance, (v) less or more than a distance associated with a usage-based auto insurance policy that is issued to the party and covers the vehicle, or (vi) less or more than an amount of time associated with the usage-based auto insurance policy; (3) determining, by the one or more processors when the risk of the loss is temporarily different from the ordinary risk of the loss, one or more terms of temporary insurance coverage for the loss having the risk that is temporarily different from the ordinary risk of the loss based upon at least one of an amount by which the risk of the loss is temporarily lower or higher than the ordinary risk of the loss, a duration for which the risk of the loss is to be temporarily lower or higher than the ordinary risk of the loss, or a distance for which the risk of the loss is to be temporarily lower or higher than the ordinary risk of the loss; and/or (4) providing, by the at least one of the one or more processors or the one or more transceivers or sensors, an indication that the temporary insurance coverage at least one of is provided or is to be provided, the temporary insurance coverage at least one of being provided or to be provided for an amount of time or for a distance based upon the duration or the distance, respectively, for which the risk of the loss is to be temporarily lower or higher than the ordinary risk of the loss, the temporary insurance coverage covering the vehicle for the loss having the risk that is temporarily different from the ordinary risk of the loss.

At least one of (i) the duration for which the risk of the loss is to be temporarily lower or higher than the ordinary risk of the loss or (ii) the distance for which the risk of the loss is to be temporarily lower or higher than the ordinary risk of the loss may be based upon a vehicle route that may be at least one of input into a vehicle navigation unit of the vehicle or selected via the vehicle navigation unit.

The predetermined distance may be a predetermined amount of miles. The distance associated with the usage-based auto insurance policy may be an amount of miles associated with the usage-based auto insurance policy, and the usage-based auto insurance policy may be a pay-by-mile auto insurance policy. Providing the indication that the temporary insurance coverage covering the vehicle at least one of is provided or is to be provided may include providing an indication that the temporary insurance coverage at least one of is provided or is to be provided for at least one of (i) the predetermined amount of miles, (ii) less than the predetermined amount of miles, or (iii) less or more than the amount of miles associated with the pay-by-mile auto insurance policy.

The usage-based auto insurance policy may be a pay-by-time auto insurance policy. Providing the indication that the temporary insurance coverage covering the vehicle at least one of is provided or is to be provided may include providing an indication that the temporary insurance coverage at least one of is provided or is to be provided for at least one of (i) the predetermined amount of time, (ii) less than the predetermined amount of time, or (iii) less or more than the amount of time associated with the pay-by-time auto insurance policy. The temporary insurance coverage may be usage-based insurance coverage.

Receiving, by the at least one of (i) the one or more processors or (ii) the one or more transceivers or sensors, the data indicative of the risk of the loss associated with the vehicle may be performed by at least one of (i) one or more processors of one or more smart vehicle devices associated with the vehicle or (ii) one or more transceivers or sensors of the one or more smart vehicle devices associated with the vehicle. The data indicative of the risk of the loss may indicate that the risk of the loss associated with the vehicle is temporarily different from the ordinary risk of the loss when the data indicative of the risk of the loss indicates at least one of abnormal vehicle congestion, abnormal traffic, abnormal weather conditions, abnormal driving conditions, an abnormal number of at least one of accidents or collisions, or road construction.

Receiving, by the at least one of (i) the one or more processors of the one or more smart vehicle devices associated with the vehicle or (ii) the one or more transceivers or sensors of the one or more smart vehicle devices associated with the vehicle, the data indicative of the risk of the loss associated with the vehicle may include receiving, by the one or more smart vehicle devices associated with the vehicle, data from one or more additional smart vehicle devices associated with one or more additional vehicles. The data indicative of the risk of the loss may indicate that the risk of the loss associated with the vehicle is temporarily different from the ordinary risk of the loss when the data from the one or more additional smart vehicle devices indicates at least one of abnormal vehicle congestion, abnormal traffic, abnormal weather conditions, abnormal driving conditions, an abnormal number of at least one of accidents or collisions, or road construction.

Determining, by the one or more processors, whether the risk of the loss associated with the vehicle is temporarily different from the ordinary risk of the loss may be performed by one or more processors of one or more smart vehicle devices associated with the vehicle based upon data received from one or more additional smart vehicle devices associated with one or more additional vehicles. The method may include sending, using the one or more smart vehicle devices associated with the vehicle, an indication to the party when the risk of the loss associated with the vehicle is temporarily different from the ordinary risk of the loss. The indication to the party may include an indication of at least one of an availability of the temporary insurance coverage, a recommendation of the temporary insurance coverage, or a price associated with the temporary insurance coverage.

The method may include providing, via one or more user interfaces, by the one or more processors, an indication of an availability of the temporary insurance coverage. The method may also include sending, by the at least one of the one or more processors or the one or more transceivers or sensors, a request to one or more insurance provider computing devices for the temporary insurance coverage for a requested amount of time or a requested distance based upon a determined duration or a determined distance, respectively, for which the risk of the loss associated with the vehicle is to be temporarily different from the ordinary risk of the loss, so as to obtain for the requested amount of time or the requested distance the temporary insurance coverage.

The one or more terms of the temporary insurance coverage may include at least one of a premium associated with the temporary insurance coverage, a deductible associated with the temporary insurance coverage, an out-of-pocket limit of liability of the party, a rating of the party upon which the temporary insurance coverage is based, a duration of the temporary insurance coverage, or an indication of one or more modifications to at least one of the usage-based auto insurance policy or additional insurance coverage maintained by the party.

The method may include additional, less, or alternate functionality, including that discussed elsewhere herein, and/or may be implemented via an appropriate computing device(s) and/or processors thereof, or via computer-executable instructions stored on non-transitory computer-readable medium or media.

### Exemplary Computer System for Providing Insurance Coverage Using Temporary Risk Data

As depicted by, and discussed in relation to, FIGS. 1-8 and 11, for example, in one aspect, a computer system for providing insurance coverage using temporary risk data may be provided. The computer system may include at least one of (i) one or more processors, or (ii) one or more transceivers or sensors. The computer system may be configured to: (1) receive data indicative of a risk of a loss associated with a vehicle (e.g., an autonomous vehicle); (2) determine, based upon the data indicative of the risk of the loss associated with the vehicle, whether the risk of the loss associated with the vehicle is temporarily different from an ordinary risk of the loss, the risk of the loss being temporarily different from the ordinary risk of the loss when the risk of the loss is lower or higher than the ordinary risk of the loss for at least one of (i) a predetermined amount of time, (ii) less than the predetermined amount of time, (iii) a predetermined distance, (iv) less than the predetermined distance, (v) less or more than a distance associated with a usage-based auto insurance policy that is issued to the party and covers the vehicle, or (vi) less or more than an amount of time associated with the usage-based auto insurance policy; (3) determine, when the risk of the loss is temporarily different from the ordinary risk of the loss, one or more terms of temporary insurance coverage for the loss having the risk that is temporarily different from the ordinary risk of the loss based upon at least one of an amount by which the risk of the loss is temporarily lower or higher than the ordinary risk of the loss, a duration for which the risk of the loss is to be temporarily lower or higher than the ordinary risk of the loss, or a distance for which the risk of the loss is to be temporarily lower or higher than the ordinary risk of the loss; and/or (4) provide an indication that the temporary insurance coverage at least one of is provided or is to be provided, the temporary insurance coverage at least one of being provided or to be provided for an amount of time or for a distance based upon the duration or the distance, respectively, for which the risk of the loss is to be temporarily lower or higher than the ordinary risk of the loss, the temporary insurance coverage covering the vehicle for the loss having the risk that is temporarily different from the ordinary risk of the loss.

At least one of (i) the duration for which the risk of the loss is to be temporarily lower or higher than the ordinary risk of the loss or (ii) the distance for which the risk of the loss is to be temporarily lower or higher than the ordinary risk of the loss may be based upon a vehicle route that may be at least one of input into a vehicle navigation unit of the vehicle or selected via the vehicle navigation unit.

The predetermined distance may be a predetermined amount of miles. The distance associated with the usage-based auto insurance policy may be an amount of miles associated with the usage-based auto insurance policy, and the usage-based auto insurance policy may be a pay-by-mile auto insurance policy. The computer system may be configured to provide the indication that the temporary insurance coverage covering the vehicle at least one of is provided or is to be provided by providing an indication that the temporary insurance coverage at least one of is provided or is to be provided for at least one of (i) the predetermined amount of miles, (ii) less than the predetermined amount of miles, or (iii) less or more than the amount of miles associated with the pay-by-mile auto insurance policy.

The usage-based auto insurance policy may be a pay-by-time auto insurance policy. The computer system may be configured to provide the indication that the temporary insurance coverage covering the vehicle at least one of is provided or is to be provided by providing an indication that the temporary insurance coverage at least one of is provided or is to be provided for at least one of (i) the predetermined amount of time, (ii) less than the predetermined amount of time, or (iii) less or more than the amount of time associated with the pay-by-time auto insurance policy. The temporary insurance coverage is usage-based insurance coverage.

One or more smart vehicle devices associated with the vehicle may be configured to receive the data indicative of the risk of the loss associated with the vehicle. The data indicative of the risk of the loss may indicate that the risk of the loss associated with the vehicle is temporarily different from the ordinary risk of the loss when the data indicative of the risk of the loss indicates at least one of abnormal vehicle congestion, abnormal traffic, abnormal weather conditions, abnormal driving conditions, an abnormal number of at least one of accidents or collisions, or road construction.

The one or more smart vehicle devices associated with the vehicle may be configured to receive the data indicative of the risk of the loss associated with the vehicle from one or more additional smart vehicle devices associated with one or more additional vehicles. The data indicative of the risk of the loss may indicate that the risk of the loss associated with the vehicle is temporarily different from the ordinary risk of the loss when the data from the one or more additional smart vehicle devices indicates at least one of abnormal vehicle congestion, abnormal traffic, abnormal weather conditions, abnormal driving conditions, an abnormal number of at least one of accidents or collisions, or road construction.

One or more smart vehicle devices associated with the vehicle may be configured to determine whether the risk of the loss associated with the vehicle is temporarily different from the ordinary risk of the loss based upon data received from one or more additional smart vehicle devices associated with one or more additional vehicles. The one or more smart vehicle devices associated with the vehicle may be configured to send an indication to the party when the risk of the loss associated with the vehicle is temporarily different from the ordinary risk of the loss. The indication to the party may include an indication of at least one of an availability of the temporary insurance coverage, a recommendation of the temporary insurance coverage, or a price associated with the temporary insurance coverage.

The computer system may be configured to provide, via one or more user interfaces, an indication of an availability of the temporary insurance coverage. The computer system may also be configured to send a request to one or more insurance provider computing devices for the temporary insurance coverage for a requested amount of time or a requested distance based upon a determined duration or a determined distance, respectively, for which the risk of the loss associated with the vehicle is to be temporarily different from the ordinary risk of the loss, so as to obtain for the requested amount of time or the requested distance the temporary insurance coverage.

The one or more terms of the temporary insurance coverage may include at least one of a premium associated with the temporary insurance coverage, a deductible associated with the temporary insurance coverage, an out-of-pocket limit of liability of the party, a rating of the party upon which the temporary insurance coverage is based, a duration of the temporary insurance coverage, or an indication of one or more modifications to at least one of the usage-based auto insurance policy or additional insurance coverage maintained by the party.

The computer system may be configured with additional, less, or alternate functionality, including that discussed elsewhere herein.

### Additional Aspects

As depicted by, and discussed in relation to, FIGS. 1-3 and 11, for example, in another aspect, a computer-implemented method of providing insurance coverage using temporary risk data may be provided. The method may include (1) receiving, at one or more insurance provider computing devices by at least one of (i) one or more processors or (ii) one or more transceivers, data indicative of a risk of a loss associated with a party; (2) determining, by the one or more processors of the one or more insurance provider computing devices, based upon the data indicative of the risk of the loss associated with the party, whether the risk of the loss associated with the party is temporarily higher than an ordinary risk of the loss, the risk of the loss being temporarily higher than the ordinary risk of the loss when the risk of the loss is higher than the ordinary risk of the loss for at least one of (i) a predetermined amount of time, (ii) less than the predetermined amount of time, or (iii) less than a period of an insurance policy that covers the loss and is issued to the party; (3) determining, by the one or more processors of the one or more insurance provider computing devices when the risk of the loss is temporarily higher than the ordinary risk of the loss, one or more terms of temporary insurance coverage for the loss having the risk that is temporarily higher than the ordinary risk of the loss based upon at least one of an amount by which the risk of the loss is temporarily higher than the ordinary risk of the loss or a duration for which the risk of the loss is to be temporarily higher than the ordinary risk of the loss; and/or (4) providing, by the at least one of the one or more processors of the one or more insurance provider computing devices or the one or more transceivers of the one or more insurance provider computing devices, for an amount of time based upon the duration for which the risk of the loss is to be temporarily higher than the ordinary risk of the loss, the temporary insurance coverage for the loss having the risk that is temporarily higher than the ordinary risk of the loss.

The data indicative of the risk of the loss associated with the party may include at least one of (i) data from one or more computing devices associated with a vehicle, the party being associated with the vehicle, (ii) data from one or more computing devices associated with one or more additional vehicles, or (iii) data available at the one or more insurance provider computing devices. Determining whether the risk of the loss associated with the party is temporarily higher than the ordinary risk of the loss may include determining, based upon the data indicative of the risk of the loss associated with the party, that the risk of the loss associated with the party is temporarily higher than the ordinary risk of the loss by determining at least one of (i) that the vehicle is within an area that includes at least one of congestion, an accident, an increased accident risk, or a predetermined weather occurrence, (ii) that the vehicle is within a predetermined distance of the at least one of the congestion, the accident, the increased accident risk, or the predetermined weather occurrence, or (iii) that the vehicle is estimated to reach the area that includes the at least one of the congestion, the accident, the increased accident risk, or the predetermined weather occurrence within a predetermined time.

The data indicative of the risk of the loss associated with the party may include at least one of (i) data generated by one or more devices associated with a vehicle, the party being associated with the vehicle, or (ii) data available at the one or more insurance provider computing devices. Determining whether the risk of the loss associated with the party is temporarily higher than the ordinary risk of the loss may include determining, based upon the data indicative of the risk of the loss associated with the party, that the risk of the loss associated with the party is temporarily higher than the ordinary risk of the loss by determining that an animal associated with the party is present within the vehicle.

The data indicative of the risk of the loss associated with the party may include at least one of (i) data generated by one or more devices associated with the party, or (ii) data available at the one or more insurance provider computing devices. Determining whether the risk of the loss associated with the party is temporarily higher than the ordinary risk of the loss may include determining, based upon the data indicative of the risk of the loss associated with the party, that the risk of the loss associated with the party is temporarily higher than the ordinary risk of the loss by determining that the party is riding a bicycle.

The data indicative of the risk of the loss associated with the party may include previous activity data corresponding to previous activity of the party. Determining whether the risk of the loss associated with the party is temporarily higher than the ordinary risk of the loss may include (i) determining habit data of the party based upon the previous activity data, the habit data being indicative of at least one habit of the insured party; and (ii) determining, based upon the habit data, whether the risk of the loss associated with the party is temporarily higher than the ordinary risk of the loss.

The data indicative of the risk of the loss associated with the party may include at least one of (i) data generated by one or more devices associated with the party, (ii) data generated by one or more devices associated with a provider of a travel service, or (iii) data available at the one or more insurance provider computing devices. Determining whether the risk of the loss associated with the party is temporarily higher than the ordinary risk of the loss may include determining, based upon the data indicative of the risk of the loss associated with the party, that the risk of the loss associated with the party is temporarily higher than the ordinary risk of the loss by determining that the party is at least one of traveling using the travel service or expected to travel using the travel service within a predetermined amount of time.

The data indicative of the risk of the loss associated with the party may include location data indicative of at least one of a location of the party or an expected future location of the party. Determining whether the risk of the loss associated with the party is temporarily higher than the ordinary risk of the loss may include determining, based upon the data indicative of the risk of the loss associated with the party, the at least one of the location of the party or the expected future location of the party.

The data indicative of the risk of the loss associated with the party may include data indicative of a rating associated with a service provider. The service provider may at least one of be providing a service to the party or be expected to provide a service to the party within a predetermined amount of time. Determining whether the risk of the loss associated with the party is temporarily higher than the ordinary risk of the loss may include determining, based upon the data indicative of the risk of the loss associated with the party, that the risk of the loss associated with the party is temporarily higher than the ordinary risk of the loss by determining that the rating associated with the service provider is at least one of at a predetermined level or below a predetermined level.

The data indicative of the risk of the loss associated with the party may include data that indicates an engagement of the party in a transaction with another party. Determining whether the risk of the loss associated with the party is temporarily higher than the ordinary risk of the loss may include determining, based upon the data indicative of the risk of the loss associated with the party, that the risk of the loss associated with the party is temporarily higher than the ordinary risk of the loss by determining that the other party has an associated risk of a fraudulent transaction that is higher than a predetermined risk.

The party may not be a customer of an insurance provider associated with the one or more insurance provider computing devices until the providing of the temporary insurance coverage for the loss having the risk that is temporarily higher than the ordinary risk of the loss.

The method may include additional, less, or alternate functionality, including that discussed elsewhere herein, and/or may be implemented via an appropriate computing device(s) and/or processors thereof, or via computer-executable instructions stored on non-transitory computer-readable medium or media.

As depicted by, and discussed in relation to, FIGS. 1-3 and 11, for example, in another aspect, a computer system for providing insurance coverage using temporary risk data may be provided. The computer system may include at least one of (i) one or more processors, or (ii) one or more transceivers. The computer system may be configured to: (1) receive data indicative of a risk of a loss associated with a party; (2) determine, based upon the data indicative of the risk of the loss associated with the party, whether the risk of the loss associated with the party is temporarily higher than an ordinary risk of the loss, the risk of the loss being temporarily higher than the ordinary risk of the loss when the risk of the loss is higher than the ordinary risk of the loss for at least one of (i) a predetermined amount of time, (ii) less than the predetermined amount of time, or (iii) less than a period of an insurance policy that covers the loss and is issued to the party; (3) determine, when the risk of the loss is temporarily higher than the ordinary risk of the loss, one or more terms of temporary insurance coverage for the loss having the risk that is temporarily higher than the ordinary risk of the loss based upon at least one of an amount by which the risk of the loss is temporarily higher than the ordinary risk of the loss or a duration for which the risk of the loss is to be temporarily higher than the ordinary risk of the loss; and/or (4) provide, for an amount of time based upon the duration for which the risk of the loss is to be temporarily higher than the ordinary risk of the loss, the temporary insurance coverage for the loss having the risk that is temporarily higher than the ordinary risk of the loss.

The data indicative of the risk of the loss associated with the party may include at least one of (i) data from one or more computing devices associated with a vehicle, the party being associated with the vehicle, (ii) data from one or more computing devices associated with one or more additional vehicles, or (iii) data available at one or more insurance provider computing devices. The computer system may be configured to determine that the risk of the loss associated with the party is temporarily higher than the ordinary risk of the loss by determining, based upon the data indicative of the risk of the loss associated with the party, at least one of (i) that the vehicle is within an area that includes at least one of congestion, an accident, an increased accident risk, or a predetermined weather occurrence, (ii) that the vehicle is within a predetermined distance of the at least one of the congestion, the accident, the increased accident risk, or the predetermined weather occurrence, or (iii) that the vehicle is estimated to reach the area that includes the at least one of the congestion, the accident, the increased accident risk, or the predetermined weather occurrence within a predetermined time.

The data indicative of the risk of the loss associated with the party may include at least one of (i) data generated by one or more devices associated with a vehicle, the party being associated with the vehicle, or (ii) data available at one or more insurance provider computing devices. The computer system may be configured to determine that the risk of the loss associated with the party is temporarily higher than the ordinary risk of the loss by determining, based upon the data indicative of the risk of the loss associated with the party, that an animal associated with the party is present within the vehicle.

The data indicative of the risk of the loss associated with the party may include at least one of (i) data generated by one or more devices associated with the party, or (ii) data available at one or more insurance provider computing devices. The computer system may be configured to determine that the risk of the loss associated with the party is temporarily higher than the ordinary risk of the loss by determining, based upon the data indicative of the risk of the loss associated with the party, that the party is riding a bicycle.

The data indicative of the risk of the loss associated with the party may include previous activity data corresponding to previous activity of the party. The computer system may be configured to (i) determine habit data of the party based upon the previous activity data, the habit data being indicative of at least one habit of the insured party, and (ii) determine, based upon the habit data, whether the risk of the loss associated with the party is temporarily higher than the ordinary risk of the loss.

The data indicative of the risk of the loss associated with the party may include at least one of (i) data generated by one or more devices associated with the party, (ii) data generated by one or more devices associated with a provider of a travel service, or (iii) data available at one or more insurance provider computing devices. The computer system may be configured to determine that the risk of the loss associated with the party is temporarily higher than the ordinary risk of the loss by determining, based upon the data indicative of the risk of the loss associated with the party, that the party is at least one of traveling using the travel service or expected to travel using the travel service within a predetermined amount of time.

The data indicative of the risk of the loss associated with the party may include location data indicative of at least one of a location of the party or an expected future location of the party. The computer system may be configured to determine whether the risk of the loss associated with the party is temporarily higher than the ordinary risk of the loss by determining, based upon the data indicative of the risk of the loss associated with the party, the at least one of the location of the party or the expected future location of the party.

The data indicative of the risk of the loss associated with the party may include data indicative of a rating associated with a service provider. The service provider may at least one of be providing a service to the party or be expected to provide a service to the party within a predetermined amount of time. The computer system may be configured to determine that the risk of the loss associated with the party is temporarily higher than the ordinary risk of the loss by determining, based upon the data indicative of the risk of the loss associated with the party, that the rating associated with the service provider is at least one of at a predetermined level or below a predetermined level.

The data indicative of the risk of the loss associated with the party may include data that indicates an engagement of the party in a transaction with another party. The computer system may be configured to determine that the risk of the loss associated with the party is temporarily higher than the ordinary risk of the loss by determining, based upon the data indicative of the risk of the loss associated with the party, that the other party has an associated risk of a fraudulent transaction that is higher than a predetermined risk.

The party may not be a customer of an insurance provider until the insurance provider provides the temporary insurance coverage for the loss having the risk that is temporarily higher than the ordinary risk of the loss.

The computer system may be configured with additional, less, or alternate functionality, including that discussed elsewhere herein.

As depicted by, and discussed in relation to, FIGS. 1-4 and 11, for example, in another aspect, a computer-implemented method of providing insurance coverage using temporary risk data determined using one or more devices associated with a party may be provided. The method may include (1) determining, at the one or more devices associated with the party by at least one of (i) one or more processors or (ii) one or more transceivers, that a risk of a loss associated with the party is temporarily higher than an ordinary risk of the loss, the risk of the loss being temporarily higher than the ordinary risk of the loss when the risk of the loss is higher than the ordinary risk of the loss for at least one of (i) a predetermined amount of time, (ii) less than the predetermined amount of time, or (iii) less than a period of an insurance policy that covers the loss and is issued to the party; (2) determining, by the at least one of the one or more processors of the one or more devices associated with the party or the one or more transceivers of the one or more devices associated with the party, one or more terms of temporary insurance coverage for the loss having the risk that is temporarily higher than the ordinary risk of the loss based upon at least one of an amount by which the risk of the loss is temporarily higher than the ordinary risk of the loss or a duration for which the risk of the loss is to be temporarily higher than the ordinary risk of the loss; (3) providing, via one or more user interfaces, by the one or more processors of the one or more devices associated with the party, an indication of an availability of the temporary insurance coverage; and/or (4) sending, by the at least one of the one or more processors of the one or more devices associated with the party or the one or more transceivers of the one or more devices associated with the party, a request to one or more insurance provider computing devices for the temporary insurance coverage for an amount of time based upon a duration for which the risk of the loss is to be temporarily higher than the ordinary risk of the loss, so as to obtain for the requested amount of time the temporary insurance coverage for the loss having the risk that is temporarily higher than the ordinary risk of the loss.

The one or more devices associated with the party may be one or more smart vehicle devices associated with a vehicle in which the party travels, and the one or more smart vehicle devices may facilitate at least one of automatic vehicle control functions or automatic vehicle monitoring functions. Determining that the risk of the loss associated with the party is temporarily higher than the ordinary risk of the loss may include determining, at the one or more smart vehicle devices based upon data received by the one or more smart vehicle devices from one or more additional smart vehicle devices associated with one or more additional vehicles, at least one of (i) that the vehicle is within an area that includes at least one of congestion, an accident, an increased accident risk, or a predetermined weather occurrence, (ii) that the vehicle is within a predetermined distance of the at least one of the congestion, the accident, the increased accident risk, or the predetermined weather occurrence, or (iii) that the vehicle is estimated to reach the area that includes the at least one of the congestion, the accident, the increased accident risk, or the predetermined weather occurrence within a predetermined time.

The one or more devices associated with the party may be one or more smart home devices associated with a residence of the party, and the one or more smart home devices may facilitate at least one of automatic residence control functions or automatic residence monitoring functions. Determining that the risk of the loss associated with the party is temporarily higher than the ordinary risk of the loss may include determining, at the one or more smart home devices based upon data received by the one or more smart home devices from one or more additional smart home devices associated with one or more additional residences within a particular proximity of the residence of the party, that at least one property crime associated with at least one of the one or more additional residences has occurred.

The one or more devices associated with the party may indicate at least one of a location of the party or a speed of the party, and determining that the risk of the loss associated with the party is temporarily higher than the ordinary risk of the loss may include determining, at the one or more devices associated with the party based upon the at least one of the location of the party or the speed of the party, that the party is riding a bicycle.

The one or more devices associated with the party may indicate previous activity data corresponding to previous activity of the party. Determining that the risk of the loss associated with the party is temporarily higher than the ordinary risk of the loss may include (i) determining habit data of the party based upon the previous activity data, where the habit data may be indicative of at least one habit of the insured party, and (ii) determining, based upon the habit data, that the risk of the loss associated with the party is temporarily higher than the ordinary risk of the loss.

Determining that the risk of the loss associated with the party is temporarily higher than the ordinary risk of the loss may include determining, by the at least one of the one or more processors or the one or more transceivers of the one or more devices associated with the party, that the party is at least one of traveling using a travel service or expected to travel using the travel service within a predetermined amount of time.

The one or more devices associated with the party may indicate location data indicative of at least one of a location of the party or an expected future location of the party, and determining that the risk of the loss associated with the party is temporarily higher than the ordinary risk of the loss may include determining that the at least one of the location of the party or the expected future location of the party is associated with a risk of the loss that is temporarily higher than the ordinary risk of the loss.

The one or more devices associated with the party may indicate an engagement of the party in a transaction with another party, and determining that the risk of the loss associated with the party is temporarily higher than the ordinary risk of the loss may include determining that the other party has an associated risk of a fraudulent transaction that is higher than a predetermined risk.

Sending the request to the one or more insurance provider computing devices for the temporary insurance coverage may be performed at least one of (i) based upon a selection by one of the party or another user associated with the party of an option to request the temporary insurance coverage in response to the one or more devices associated with the party providing at least one of (a) the option to request the temporary insurance coverage to the one of the party or the other user associated with the party or (b) an indication that the risk of the loss associated with the party is temporarily higher than the ordinary risk of the loss, or (ii) automatically by the at least one of the one or more processors or the one or more transceivers of the one or more devices associated with the party based upon the determining, by the at least one of the one or more processors or the one or more transceivers of the one or more devices associated with the party, that the risk of the loss associated with the party is temporarily higher than the ordinary risk of the loss.

The party may not be a customer of an insurance provider associated with the one or more insurance provider computing devices at a time of the sending of the request for the temporary insurance coverage to the one or more insurance provider computing devices.

The method may include additional, less, or alternate functionality, including that discussed elsewhere herein, and/or may be implemented via an appropriate computing device(s) and/or processors thereof, or via computer-executable instructions stored on non-transitory computer-readable medium or media.

As depicted by, and discussed in relation to, FIGS. 1-4 and 11, for example, in another aspect, a computer system for providing insurance coverage using temporary risk data determined using one or more devices associated with a party may be provided. The computer system may include at least one of (i) one or more processors, or (ii) one or more transceivers. The computer system may be configured to: (1) determine that a risk of a loss associated with the party is temporarily higher than an ordinary risk of the loss, the risk of the loss being temporarily higher than the ordinary risk of the loss when the risk of the loss is higher than the ordinary risk of the loss for at least one of (i) a predetermined amount of time, (ii) less than the predetermined amount of time, or (iii) less than a period of an insurance policy that covers the loss and is issued to the party; (2) determine one or more terms of temporary insurance coverage for the loss having the risk that is temporarily higher than the ordinary risk of the loss based upon at least one of an amount by which the risk of the loss is temporarily higher than the ordinary risk of the loss or a duration for which the risk of the loss is to be temporarily higher than the ordinary risk of the loss; (3) provide, via one or more user interfaces, an indication of an availability of the temporary insurance coverage; and/or (4) send a request to one or more insurance provider computing devices for the temporary insurance coverage for an amount of time based upon a duration for which the risk of the loss is to be temporarily higher than the ordinary risk of the loss, so as to obtain for the requested amount of time the temporary insurance coverage for the loss having the risk that is temporarily higher than the ordinary risk of the loss.

The computer system may be configured with additional, less, or alternate functionality, including that discussed elsewhere herein.

As depicted by, and discussed in relation to, FIGS. 1-6 and 11, for example, in another aspect, a computer-implemented method of determining one or more terms of insurance coverage using temporary risk data may be provided. The method may include (1) receiving, at one or more insurance provider computing devices by at least one of (i) one or more processors or (ii) one or more transceivers, data indicative of a risk of a loss associated with a party; (2) determining, by the one or more processors of the one or more insurance provider computing devices, based upon the data indicative of the risk of the loss associated with the party, that the risk of the loss associated with the party is temporarily higher than an ordinary risk of the loss, the risk of the loss being temporarily higher than the ordinary risk of the loss when the risk of the loss is higher than the ordinary risk of the loss for at least one of (i) a predetermined amount of time, (ii) less than the predetermined amount of time, or (iii) less than a period of an insurance policy that covers the loss and is issued to the party; (3) determining, by the one or more processors of the one or more insurance provider computing devices, one or more terms of temporary insurance coverage for the loss having the risk that is temporarily higher than the ordinary risk of the loss based upon at least one of an amount by which the risk of the loss is temporarily higher than the ordinary risk of the loss, a duration for which the risk of the loss is to be temporarily higher than the ordinary risk of the loss, a type of the loss, one or more attributes of the party, or one or more selections made by the party that are communicated to the one or more insurance provider computing devices; and/or (4) providing, by the at least one of the one or more processors of the one or more insurance provider computing devices or the one or more transceivers of the one or more insurance provider computing devices, for an amount of time based upon the duration for which the risk of the loss is to be temporarily higher than the ordinary risk of the loss, the temporary insurance coverage having the one or more determined terms.

The one or more terms of the temporary insurance coverage may include at least one of one or more types of the temporary insurance coverage, a premium associated with the temporary insurance coverage, a deductible associated with the temporary insurance coverage, an out-of-pocket limit of liability of the party associated with the temporary insurance coverage, a rating of the party upon which the temporary insurance coverage is based, a duration of the temporary insurance coverage, or an indication of one or more modifications to one or more terms of additional insurance coverage maintained by the party.

The one or more types of the temporary insurance coverage may include at least one of auto, home, life, health, or renters insurance. The one or more types of the temporary insurance coverage may also include usage-based insurance, such as auto insurance measured by mileage or time, including pay-by-mile auto insurance.

Additionally or alternatively, the one or more types of the temporary insurance coverage may include at least one of liability insurance coverage, insurance coverage covering loss of property, insurance coverage covering loss of use of property, insurance coverage covering damage to property, insurance coverage covering theft of property, insurance coverage covering personal injury associated with the party, insurance coverage that provides fraud protection to the party, business insurance coverage, life insurance coverage, pet insurance coverage, travel insurance coverage, automotive insurance coverage, or litigation insurance coverage. The additional insurance coverage maintained by the party may include longer-duration insurance coverage for the loss having the risk that is higher than the ordinary risk of the loss, the longer-duration insurance coverage being insurance coverage for a duration that is at least one of at least a predetermined duration or a duration longer than the amount of time for which the temporary insurance coverage is to be provided. The one or more modifications to the one or more terms of the additional insurance coverage maintained by the party may include at least one of a reduction of a deductible associated with the longer-duration insurance coverage, an amount of time for which the reduction of the deductible associated with the longer-duration insurance coverage is effective, a reduction of an out-of-pocket limit of liability of the party associated with the longer-duration insurance coverage, or an amount of time for which the reduction of the out-of-pocket limit of liability of the party associated with the longer-duration insurance coverage is effective.

The one or more attributes of the party may include at least one of an occupation of the party, at least one asset associated with the party, or a location of the party. The method may include receiving, by the at least one of the one or more processors or the one or more transceivers of the one or more insurance provider computing devices, an indication from at least one of the party or a computing device associated with the party of a number of units of the temporary insurance coverage that the party is to purchase. Each one of the number of units of the temporary insurance coverage may correspond to at least one of one or more types of the temporary insurance coverage, a monetary amount associated with the temporary insurance coverage, a duration of the temporary insurance coverage, or an indication of one or more modifications to one or more terms of additional insurance coverage maintained by the party.

The method may include receiving, by the at least one of the one or more processors or the one or more transceivers of the one or more insurance provider computing devices, at least one of (i) a selection by one of the party or another user associated with the party to request the temporary insurance coverage in response to at least one of (a) an option being provided, based upon the determining that the risk of the loss is temporarily higher than the ordinary risk of the loss, to the one of the party or the other user associated with the party to request the temporary insurance coverage or (b) an indication being provided, based upon the determining that the risk of the loss is temporarily higher than the ordinary risk of the loss, to the one of the party or the other user associated with the party that the risk of the loss is temporarily higher than the ordinary risk of the loss, or (ii) a request from a computing device associated with the party to purchase the temporary insurance coverage, the request being received automatically from the computing device associated with the party based upon the determining that the risk of the loss is temporarily higher than the ordinary risk of the loss. Providing the temporary insurance coverage may be performed in response to the receiving the at least one of (i) the selection by the one of the party or the other user associated with the party to request the temporary insurance coverage or (ii) the request that is received automatically from the computing device associated with the party.

The method may include using, by the at least one of the one or more processors or the one or more transceivers of the one or more insurance provider computing devices, historical data regarding the providing of the temporary insurance coverage to the party to adjust one or more terms of additional insurance coverage provided to the party by an insurance provider associated with the one or more insurance provider computing devices. The additional insurance coverage may include longer-duration insurance coverage for the loss having the risk that is higher than the ordinary risk of the loss, where the longer-duration insurance coverage may be insurance coverage for a duration that is at least one of at least a predetermined duration or a duration longer than the amount of time for which the temporary insurance coverage is provided.

The method may include using, by the at least one of the one or more processors or the one or more transceivers of the one or more insurance provider computing devices, historical data regarding the providing of the temporary insurance coverage to the party to adjust a marketing profile of the party. The marketing profile of the party may be used to at least one of (i) offer at least one of goods or services sold by an insurance provider associated with the one or more insurance provider computing devices to the party, or (ii) offer at least one of goods or services sold by an entity with which the insurance provider partners to the party.

The party may not be a customer of an insurance provider associated with the one or more insurance provider computing devices until the providing of the temporary insurance coverage for the loss having the risk that is temporarily higher than the ordinary risk of the loss.

The method may include additional, less, or alternate functionality, including that discussed elsewhere herein, and/or may be implemented via an appropriate computing device(s) and/or processors thereof, or via computer-executable instructions stored on non-transitory computer-readable medium or media.

As depicted by, and discussed in relation to, FIGS. 1-6 and 11, for example, in another aspect, a computer system for determining one or more terms of insurance coverage using temporary risk data may be provided. The computer system may include at least one of (i) one or more processors, or (ii) one or more transceivers. The computer system may be configured to: (1) receive data indicative of a risk of a loss associated with a party; (2) determine, based upon the data indicative of the risk of the loss associated with the party, that the risk of the loss associated with the party is temporarily higher than an ordinary risk of the loss, the risk of the loss being temporarily higher than the ordinary risk of the loss when the risk of the loss is higher than the ordinary risk of the loss for at least one of (i) a predetermined amount of time, (ii) less than the predetermined amount of time, or (iii) less than a period of an insurance policy that covers the loss and is issued to the party; (3) determine one or more terms of temporary insurance coverage for the loss having the risk that is temporarily higher than the ordinary risk of the loss based upon at least one of an amount by which the risk of the loss is temporarily higher than the ordinary risk of the loss, a duration for which the risk of the loss is to be temporarily higher than the ordinary risk of the loss, a type of the loss, one or more attributes of the party, or one or more selections made by the party that are communicated to one or more insurance provider computing devices; and/or (4) provide, for an amount of time based upon the duration for which the risk of the loss is to be temporarily higher than the ordinary risk of the loss, the temporary insurance coverage having the one or more determined terms.

The computer system may be configured with additional, less, or alternate functionality, including that discussed elsewhere herein.

### Additional Considerations

With the foregoing, a party—whether or not already insured by an insurance provider—may opt-in to have data indicative of a risk of a loss associated with a vehicle made available to an insurance provider. After the party provides its permission or affirmative consent, such data may be made available in order for the party to obtain temporary insurance coverage from the insurance provider that is of an appropriate type(s), duration, etc. to insure against a risk of a loss associated with the vehicle that has been determined to be temporarily different from an ordinary risk of the loss. As a result, insurance cost savings may be passed on to risk-averse customers and/or other parties, and such parties may obtain the temporary insurance coverage for a suitable duration as opposed to, for instance, carrying an increased amount of a particular type of insurance coverage (e.g., automobile insurance coverage) for a conventional period of time (e.g., an entire year) when such an increased amount of automobile insurance coverage is not needed for an entire year.

Although the disclosure provides several examples in terms of types of determining whether and/or that a risk of a loss associated with a party is temporarily different from an ordinary risk of the loss; several examples of determinations of terms of temporary insurance coverage; etc., aspects include any suitable type(s) of determinations of temporarily different risk based upon any suitable factors; any suitable determinations of terms of temporary insurance coverage; etc. The systems and methods described herein are directed to an improvement(s) to computer functionality and improve the functioning of conventional computers, and/or are directed to an improvement(s) in computer-related technology, and/or provide insurance coverage in a non-conventional and non-generic way, such as by the non-conventional and non-generic use of data regarding temporary risk as described herein.

Although the foregoing text sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

The following considerations also apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules may provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors, and/or processor-implemented modules, may be located in a single location (e.g., within a home environment, an office environment or as a server farm), while in other embodiments the processor(s) and/or processor-implemented modules may be distributed across a number of locations.

The patent claims at the end of this patent application are not intended to be construed under 35 U.S.C. § 112(f) unless traditional means-plus-function language is expressly recited, such as “means for” or “step for” language being explicitly recited in the claim(s).

This detailed description is to be construed as exemplary only and does not describe every possible embodiment, as describing every possible embodiment would be impractical, if not impossible. One may implement numerous alternate embodiments, using either current technology or technology developed after the filing date of this application.

1. A computer-implemented method of providing insurance coverage using risk data, the method comprising:
generating, at one or more sensors included in a vehicle traveling on a route, first telematics data, the first telematics data including an indication of the route;
collecting, at a vehicle controller of the vehicle, second telematics data from at least one of a second vehicle or a roadside infrastructure device;
receiving, by one or more processors from the vehicle controller, telematics data including the first and the second telematics data;
detecting, by the one or more processors, based on the telematics data, a variable condition in an operating environment of the vehicle ahead of the vehicle along the route;
determining, by the one or more processors, a risk of a loss associated with the vehicle based upon the variable condition;
determining, by the one or more processors, a duration of the risk of the loss;
determining, by the one or more processors, based upon the risk of the loss associated with the vehicle, the risk of the loss associated with the vehicle is different from an ordinary risk of the loss during the determined duration of the risk of the loss, the risk of the loss being different from the ordinary risk of the loss when the risk of the loss is lower or higher than the ordinary risk of the loss for at least one of (i) a predetermined amount of time, (ii) less than the predetermined amount of time, (iii) a predetermined distance, (iv) less than the predetermined distance, (v) less or more than a distance associated with a usage-based auto insurance policy that is issued to a party associated with the vehicle and covers the vehicle, or (vi) less or more than an amount of time associated with the usage-based auto insurance policy;
determining, by the one or more processors when the risk of the loss is different from the ordinary risk of the loss during the determined duration of the risk of the loss, one or more terms of insurance coverage for the loss having the risk that is different from the ordinary risk of the loss; and
providing, by the one or more processors, an indication that the insurance coverage at least one of is provided or is to be provided.

2. The computer-implemented method of claim 1, wherein the vehicle is an autonomous vehicle.

3. The computer-implemented method of claim 1, wherein at least one of (i) a duration for which the risk of the loss is to be lower or higher than the ordinary risk of the loss or (ii) a distance for which the risk of the loss is to be lower or higher than the ordinary risk of the loss is based upon the route, wherein the route is (i) at least one of input into a vehicle navigation unit of the vehicle or selected via the vehicle navigation unit and (ii) received at the one or more processors.

4. The computer-implemented method of claim 1, wherein the predetermined distance is a predetermined amount of miles, wherein the distance associated with the usage-based auto insurance policy is an amount of miles associated with the usage-based auto insurance policy, wherein the usage-based auto insurance policy is a pay-by-mile auto insurance policy, and wherein providing the indication that the insurance coverage covering the vehicle at least one of is provided or is to be provided includes providing an indication that the insurance coverage at least one of is provided or is to be provided for at least one of (i) the predetermined amount of miles, (ii) less than the predetermined amount of miles, or (iii) less or more than the amount of miles associated with the pay-by-mile auto insurance policy.

5. The computer-implemented method of claim 1, wherein the usage-based auto insurance policy is a pay-by-time auto insurance policy, and wherein providing the indication that the insurance coverage covering the vehicle at least one of is provided or is to be provided includes providing an indication that the insurance coverage at least one of is provided or is to be provided for at least one of (i) the predetermined amount of time, (ii) less than the predetermined amount of time, or (iii) less or more than the amount of time associated with the pay-by-time auto insurance policy.

6. The computer-implemented method of claim 1, wherein the insurance coverage is usage-based insurance coverage.

7. The computer-implemented method of claim 1, wherein detecting the variable condition includes detecting at least one of vehicle congestion, traffic, weather conditions, a number of at least one of accidents or collisions exceeding a predetermined number, or road construction.

8. The computer-implemented method of claim 1, wherein collecting the second telematics data includes collecting the second telematics data from one or more additional smart vehicle devices associated with one or more additional vehicles.

9. The computer-implemented method of claim 1, wherein determining, by the one or more processors, the risk of the loss associated with the vehicle is different from the ordinary risk of the loss is performed by one or more processors of one or more smart vehicle devices associated with the vehicle based upon the telematics data, the method further including sending, using the one or more smart vehicle devices associated with the vehicle, an indication to the party when the risk of the loss associated with the vehicle is different from the ordinary risk of the loss, the indication to the party including an indication of at least one of an availability of the insurance coverage, a recommendation of the insurance coverage, or a price associated with the insurance coverage.

10. The computer-implemented method of claim 1, further including:
providing, via one or more user interfaces, by the one or more processors, an indication of an availability of the insurance coverage; and
sending, by the one or more processors, a request to one or more insurance provider computing devices for the insurance coverage for a requested amount of time or a requested distance based upon a determined duration or a determined distance, respectively, for which the risk of the loss associated with the vehicle is to be different from the ordinary risk of the loss, so as to obtain for the requested amount of time or the requested distance the insurance coverage.

11. The computer-implemented method of claim 1, wherein the one or more terms of the insurance coverage include at least one of a premium associated with the insurance coverage, a deductible associated with the insurance coverage, an out-of-pocket limit of liability of the party, a rating of the party upon which the insurance coverage is based, a duration of the insurance coverage, or an indication of one or more modifications to at least one of the usage-based auto insurance policy or additional insurance coverage maintained by the party.

12. A computer system for providing insurance coverage using risk data, the computer system comprising:
one or more sensors included in a vehicle travelling on a route, the one or more sensors configured to generate first telematics data, the first telematics data including an indication of the route;
a vehicle controller of the vehicle, the vehicle controller configured to collect second telematics data from at least one of a second vehicle or a roadside infrastructure device;
one or more processors, the one or more processors configured to:
receive, from the vehicle controller, telematics data including the first and the second telematics data;
detect, based on the telematics data, a variable condition in an operating environment of the vehicle ahead of the vehicle along the route;
determine a risk of a loss associated with the vehicle based upon the variable condition;
determine a duration of the risk of the loss;
determine, based upon the risk of the loss associated with the vehicle, the risk of the loss associated with the vehicle is different from an ordinary risk of the loss during the determined duration of the risk of the loss, the risk of the loss being different from the ordinary risk of the loss when the risk of the loss is lower or higher than the ordinary risk of the loss for at least one of (i) a predetermined amount of time, (ii) less than the predetermined amount of time, (iii) a predetermined distance, (iv) less than the predetermined distance, (v) less or more than a distance associated with a usage-based auto insurance policy that is issued to a party associated with the vehicle and covers the vehicle, or (vi) less or more than an amount of time associated with the usage-based auto insurance policy;
determine, when the risk of the loss is different from the ordinary risk of the loss during the determined duration of the risk of the loss, one or more terms of insurance coverage for the loss having the risk that is different from the ordinary risk of the loss; and
provide an indication that the insurance coverage at least one of is provided or is to be provided.

13. The computer system of claim 12, wherein the vehicle is an autonomous vehicle.

14. The computer system of claim 12, wherein at least one of (i) a duration for which the risk of the loss is to be lower or higher than the ordinary risk of the loss or (ii) a distance for which the risk of the loss is to be lower or higher than the ordinary risk of the loss is based upon the route, wherein the route is (i) at least one of input into a vehicle navigation unit of the vehicle or selected via the vehicle navigation unit and (ii) received at the one or more processors.

15. The computer system of claim 12, wherein the predetermined distance is a predetermined amount of miles, wherein the distance associated with the usage-based auto insurance policy is an amount of miles associated with the usage-based auto insurance policy, wherein the usage-based auto insurance policy is a pay-by-mile auto insurance policy, and wherein the one or more processors are configured to provide the indication that the insurance coverage covering the vehicle at least one of is provided or is to be provided by providing an indication that the insurance coverage at least one of is provided or is to be provided for at least one of (i) the predetermined amount of miles, (ii) less than the predetermined amount of miles, or (iii) less or more than the amount of miles associated with the pay-by-mile auto insurance policy.

16. The computer system of claim 12, wherein the usage-based auto insurance policy is a pay-by-time auto insurance policy, and wherein the one or more processors are configured to provide the indication that the insurance coverage covering the vehicle at least one of is provided or is to be provided by providing an indication that the insurance coverage at least one of is provided or is to be provided for at least one of (i) the predetermined amount of time, (ii) less than the predetermined amount of time, or (iii) less or more than the amount of time associated with the pay-by-time auto insurance policy.

17. The computer system of claim 12, wherein the insurance coverage is usage-based insurance coverage.

18. The computer system of claim 12, wherein the one or more processors are configured to detect the variable condition by detecting at least one of vehicle congestion, traffic, weather conditions, a number of at least one of accidents or collisions exceeding a predetermined threshold, or road construction.

19. The computer system of claim 12, wherein the vehicle controller is configured to collect the second telematics data from one or more additional smart vehicle devices associated with one or more additional vehicles.

20. The computer system of claim 12, wherein the one or more processors are included in one or more smart vehicle devices associated with the vehicle, and wherein the one or more processors are configured to determine the risk of the loss associated with the vehicle is different from the ordinary risk of the loss based upon the telematics data, and wherein the one or more smart vehicle devices associated with the vehicle are configured to send an indication to the party when the risk of the loss associated with the vehicle is different from the ordinary risk of the loss, wherein the indication to the party includes an indication of at least one of an availability of the insurance coverage, a recommendation of the insurance coverage, or a price associated with the insurance coverage.

21. The computer system of claim 12, wherein the one or more processors are further configured to:
provide, via one or more user interfaces, an indication of an availability of the insurance coverage; and
send a request to one or more insurance provider computing devices for the insurance coverage for a requested amount of time or a requested distance based upon a determined duration or a determined distance, respectively, for which the risk of the loss associated with the vehicle is to be different from the ordinary risk of the loss, so as to obtain for the requested amount of time or the requested distance the insurance coverage.

22. The computer system of claim 12, wherein the one or more terms of the insurance coverage include at least one of a premium associated with the insurance coverage, a deductible associated with the insurance coverage, an out-of-pocket limit of liability of the party, a rating of the party upon which the insurance coverage is based, a duration of the insurance coverage, or an indication of one or more modifications to at least one of the usage-based auto insurance policy or additional insurance coverage maintained by the party.
